(19) United States
(12) Patent Application Publication
(10) Pub. No.: US 2026/0288466 A1
(43) Pub. Date: Sep. 24, 2026

(54) SYSTEM

(71) Applicant: SoftBank Group Corp., Tokyo (JP)

(72) Inventor: Yoshiyuki OSAKABE, Tokyo (JP)

(73) Assignee: SoftBank Group Corp., Tokyo (JP)

(21) Appl. No.: 19/562,955

(22) Filed: Mar. 11, 2026

(30) Foreign Application Priority Data
Mar. 19, 2025 (JP) 2025-044974

(51) Int. Cl. G06F 9/38

(52) U.S. Cl. CPC G06F 9/3861

(57) ABSTRACT

A system includes a processor that is configured to input a prompt sentence provided by a user to a generative AI model by using a prompt that instructs the generative AI model to analyze a setting and content of a virtual environment, transmit data obtained from the generative AI model to a digital content generation device to provide data for constructing the virtual environment, and receive feedback from the user and input a new prompt sentence to the generative AI model to modify the virtual environment.

### CROSS-REFERENCE TO RELATED APPLICATION

This application is based on and claims priority under 35 USC 119 from Japanese Patent Application No. 2025-044974 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional digital content production workflows for constructing virtual environments, such as game worlds or interactive simulations, require human creators to manually translate conceptual ideas, expressed in natural language, into low-level configuration data, scripts, and asset placement instructions that can be processed by digital content generation devices, for example three-dimensional content generation engines or interactive content creation tools. This manual translation process is time-consuming, requires specialized technical skills, and often involves iterative trial-and-error cycles between designers and technical operators. As a result, it is difficult for users who are not experts in such tools to efficiently create or modify complex virtual environments in accordance with their intentions. Furthermore, when a user wishes to revise the virtual environment based on feedback or changing requirements, the user must again perform manual operations to adjust parameters, reposition objects, or rewrite scripts, which further increases workload and development time. There is therefore a need for a system that can interpret user-provided prompts in natural language, automatically generate appropriate data for constructing a virtual environment, and flexibly modify the virtual environment in response to user feedback, thereby reducing the burden on the user and enabling more efficient content creation.

### SUMMARY

In order to solve the above-described problems, according to one aspect, there is provided a system comprising a processor, wherein the processor is configured to input a prompt sentence provided by a user to a generative AI model by using a prompt that instructs the generative AI model to analyze a setting and content of a virtual environment, to transmit data obtained from the generative AI model to a digital content generation device to provide data for constructing the virtual environment, and to receive feedback from the user and input a new prompt sentence to the generative AI model to modify the virtual environment. In one embodiment, the processor is configured to construct the virtual environment by using, as the digital content generation device, a three-dimensional content generation engine or an interactive content creation tool, whereby the system can directly control existing production pipelines for three-dimensional or interactive content. In another embodiment, the processor is configured to use a generative AI model that performs natural language processing to analyze the prompt and to extract information relating to the setting and the content of the virtual environment, thereby enabling automatic interpretation of user intentions expressed in natural language and automatic generation and updating of the data required for constructing and modifying the virtual environment.

The term “system” refers to a combination of hardware and software components, including at least one processor and associated memory and interfaces, that cooperatively perform the functions described in the claims.

The term “processor” refers to one or more hardware processing units, such as a central processing unit (CPU), graphics processing unit (GPU), digital signal processor (DSP), microcontroller, or a combination thereof, that execute instructions to perform the functions specified in the claims.

The term “user” refers to a human operator or content creator who interacts with the system by providing prompt sentences, feedback, or other inputs that express intentions regarding a virtual environment.

The term “prompt sentence” refers to a natural language expression, including one or more sentences or phrases, provided by the user to indicate a desired setting, content, behavior, or modification of a virtual environment.

The term “generative AI model” refers to a machine-learned model, such as a neural network-based generative model, configured to generate or transform data in response to input prompts, and capable of analyzing the setting and content of a virtual environment based on user-provided prompt sentences.

The term “prompt” refers to data provided to the generative AI model, including at least the prompt sentence and optionally additional instructions or context, that causes the generative AI model to perform analysis or generation related to the setting and content of a virtual environment.

The term “virtual environment” refers to a computer-generated environment, including but not limited to a game world, simulation space, or interactive scene, in which digital objects, characters, or other elements are arranged and can be displayed or interacted with on an electronic display.

The term “setting of a virtual environment” refers to information defining overall characteristics of the virtual environment, including at least a theme, location, atmosphere, rules, or constraints that characterize the environment as a whole.

The term “content of a virtual environment” refers to concrete elements arranged within the virtual environment, including objects, characters, terrain, buildings, lights, effects, and other digital assets, and relationships or behaviors associated with those elements.

The term “data obtained from the generative AI model” refers to output information generated by the generative AI model in response to a prompt, including but not limited to structured data, configuration parameters, object layout information, scripts, or commands usable by a digital content generation device to construct or modify a virtual environment.

The term “digital content generation device” refers to hardware and software, including at least one application or engine, that is configured to generate, edit, or render digital content, and that can construct or modify a virtual environment based on data provided from the processor.

The term “three-dimensional content generation engine” refers to a digital content generation device that is specifically configured to construct, edit, and render three-dimensional scenes, including placement of three-dimensional objects, lighting, cameras, and animations, for purposes such as games, simulations, or visualizations.

The term “interactive content creation tool” refers to a digital content generation device that is configured to create or edit content that responds to user input or other events, such as game engines, authoring tools for interactive applications, or similar software capable of defining interactive behavior within a virtual environment.

The term “feedback from the user” refers to information provided by the user after inspection of the constructed virtual environment, including evaluations, instructions, corrections, or additional requests for changes, expressed in natural language or other input formats.

The term “new prompt sentence” refers to a prompt sentence that is provided after initial construction of the virtual environment, and that is based at least in part on the feedback from the user, and that instructs the generative AI model to modify or refine the virtual environment.

The term “natural language processing” refers to processing performed by the generative AI model that interprets and analyzes text expressed in a human language, in order to extract semantic information such as entities, relationships, constraints, and intentions relevant to the setting and content of a virtual environment.

The term “extract information relating to the setting and the content of the virtual environment” refers to obtaining, from a prompt sentence by means of natural language processing, structured information such as scene parameters, object types, counts, positions, relationships, or behavioral conditions that can be used to construct or modify the virtual environment.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

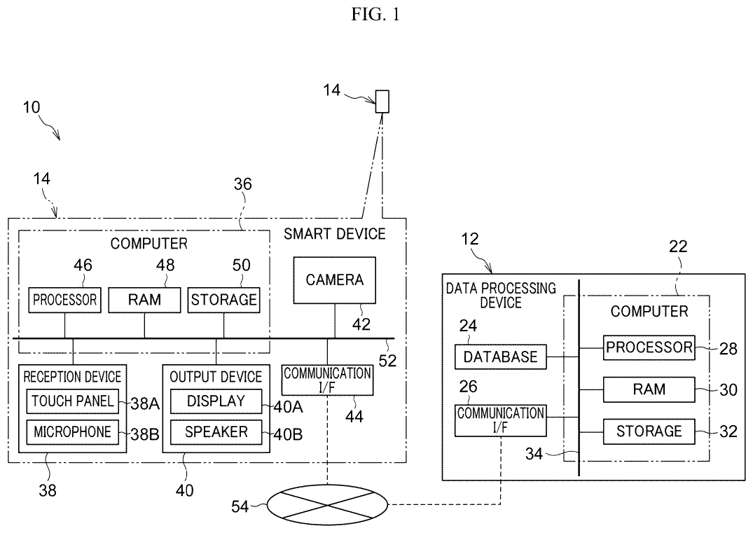

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

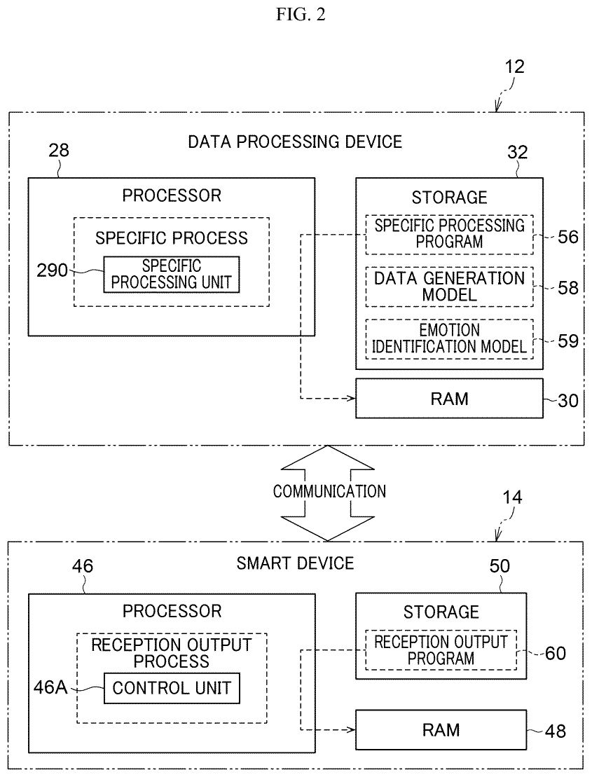

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content production systems for virtual environments, such as game or simulation authoring tools, rely heavily on manual design work performed directly in authoring interfaces. Even when a generative AI model is used to create ideas or text descriptions, existing approaches typically treat the model output as an isolated suggestion that must be manually interpreted and converted by a human operator into engine-specific data structures. As a result, a computing apparatus is not effectively utilized to transform a natural language prompt sentence into concrete, structured content data that can be directly consumed by a digital content generation apparatus.

In particular, a processor in existing systems generally performs only a one-way operation of sending a prompt sentence to a generative AI model and returning a raw, unstructured response to a user. The processor does not perform systematic extraction of entities, scenes, objects, events, and relationships from the AI output, does not normalize such elements into intermediate data according to a predefined data structure for content production, and does not automatically convert the intermediate data into engine-ready content generation data. Consequently, a large amount of manual work is required to bridge the gap between natural language descriptions and executable content configurations, which leads to inefficiencies, inconsistency in data structures, and limits on scalability.

Furthermore, conventional systems do not provide an automated feedback loop in which a processor evaluates generated digital content against the original user intention expressed in the prompt sentence. In many cases, there is no mechanism for the computer system itself to analyze digital content generated by a content engine, compare that content to the user's intended virtual environment, and automatically refine the underlying data. Without such an automated, AI-assisted evaluation and correction loop, a user must repeatedly inspect the generated content, manually identify discrepancies, and craft new prompts or configuration changes, which increases latency, consumes computational resources inefficiently, and degrades the overall user experience.

In addition, existing techniques typically lack a structured mechanism for integrating a generative AI model into the full production pipeline—from acquisition of the prompt sentence at a user terminal, through AI-based analysis and data transformation, to batch or command-line execution of a digital content generation apparatus and retrieval of log or status information. This absence of end-to-end automation prevents a processor from efficiently orchestrating the generation, verification, and regeneration of digital content. As a result, the potential of generative AI models to improve the internal operation of the computer system—such as data structure consistency, automated error handling, and repeatable asset generation—is not realized.

Accordingly, there is a need for a computer-implemented technique that improves the functioning of a processing system by: (i) systematically converting a natural language prompt sentence into structured intermediate data and engine-ready content generation data; (ii) automatically invoking a digital content generation apparatus in a batch or command-line manner; (iii) programmatically analyzing generated digital content; and (iv) using a generative AI model to evaluate alignment with user intention and to drive an iterative correction loop. Such a technique should reduce manual intervention, provide a more deterministic data pipeline, and enhance the technical performance and reliability of digital content generation for virtual environments.

The specific processing by the specific processing unit 290 of the data processing device 12 in Example 1 is realized by the following means.

The present invention provides a server comprising a processor and a storage device, the processor being configured to receive character information including a prompt sentence from a user terminal and store the character information in the storage device in association with user identification information and request identification information; to convert the stored prompt sentence into model input data for an information processing apparatus including a generative AI model, input the model input data to the generative AI model to execute analysis processing based on natural language processing, and obtain analysis result data including structured information relating to a virtual environment; to extract entities, scenes, objects, events, and relationships included in the analysis result data, convert the extracted elements into intermediate data according to a data structure for content production of an interactive application, and convert the intermediate data into content generation data in a format usable by a digital content generation apparatus; to input the content generation data to the digital content generation apparatus having a three-dimensional content generation function or an interactive content generation function, and cause the digital content generation apparatus to generate digital content corresponding to the virtual environment; to analyze components included in the digital content based on an output from the digital content generation apparatus and generate evaluation description information indicating a correspondence relationship between the components and user intention based on the prompt sentence; to input the evaluation description information and the prompt sentence as comparison evaluation model input data to the generative AI model and cause the generative AI model to generate evaluation result information including mismatch elements between the user intention and the digital content and modification proposals; to automatically correct at least a part of the intermediate data or the content generation data based on the evaluation result information, re-input corrected data to the digital content generation apparatus, and repeatedly execute regeneration processing of the digital content until a predetermined condition is satisfied; and to generate summary information relating to the digital content at a time of termination of the repeated execution and transmit the summary information to the user terminal. This enables the server to improve computer functionality by providing an automated, closed-loop pipeline that transforms natural language prompt sentences into engine-ready content data, invokes a digital content generation apparatus in a controlled batch or command-line manner, programmatically evaluates and corrects generated digital content using a generative AI model, and thereby reduces manual intervention, increases consistency of internal data structures, and enhances efficiency and reliability of virtual environment generation.

The term “processor” refers to a hardware or virtual computation unit, such as a central processing unit or a processing core, configured to execute instructions of a program to perform data processing, control, and communication operations within the system.

The term “storage device” refers to a hardware or logical memory resource, such as a volatile memory or a non-volatile memory, configured to store character information, identification information, analysis result data, intermediate data, content generation data, summary information, and other processing-related data.

The term “user terminal” refers to an information processing apparatus operated by a user, such as a general-purpose computer, a mobile communication device, or a tablet device, configured to transmit a prompt sentence and receive display information from the server via a communication network.

The term “character information” refers to digital data representing one or more characters, strings, or texts, including at least a prompt sentence input by a user, and optionally including additional metadata related to the user or the request.

The term “prompt sentence” refers to natural language text supplied by a user that specifies a desired virtual environment, scenario, or content, and that serves as an input to the generative AI model for analysis and content generation.

The term “user identification information” refers to data that uniquely or pseudo-uniquely identifies a user, such as a user ID, account identifier, or session identifier, used for associating requests and results with a particular user.

The term “request identification information” refers to data that uniquely or pseudo-uniquely identifies an individual processing request, such as a request ID or transaction identifier, used for tracking and managing processing related to a specific prompt sentence.

The term “information processing apparatus” refers to a computing resource, which may include one or more processors and accelerators, configured to execute a generative AI model and to perform natural language processing on model input data.

The term “generative AI model” refers to a machine learning model configured to perform generative processing on input data, including natural language understanding and content generation, and to output structured or unstructured data based on learned parameters.

The term “model input data” refers to data formatted in a manner suitable for input to the generative AI model, including at least the prompt sentence and optionally including system instructions, context information, or additional control parameters.

The term “analysis result data” refers to data output by the generative AI model in response to the model input data, including at least structured information that describes elements of a virtual environment derived from the prompt sentence.

The term “structured information” refers to data organized according to a predefined schema or format, such as key-value pairs or hierarchical data structures, representing entities, scenes, objects, events, relationships, or other elements relevant to a virtual environment.

The term “virtual environment” refers to a computer-generated representation of a world, space, or scenario, including spatial, narrative, interactive, or visual elements, which may be used in interactive applications such as games or simulations.

The term “entity” refers to a logical or physical element within a virtual environment, such as a character, non-player character, creature, or conceptual actor, that may have attributes, behaviors, or relationships.

The term “scene” refers to a location, area, or context within a virtual environment, such as a region or stage, in which entities, objects, and events are placed or occur.

The term “object” refers to a tangible or intangible item within a virtual environment, such as an item, tool, resource, or environmental element, that may interact with entities or events.

The term “event” refers to an occurrence or action within a virtual environment, such as a quest step, combat encounter, or scripted sequence, which may change the state of entities, scenes, or objects.

The term “relationship” refers to an association or linkage between two or more elements within a virtual environment, such as a connection between entities, dependencies between events, or spatial relations between scenes and objects.

The term “intermediate data” refers to data derived from the analysis result data, normalized and structured according to a predefined data structure for content production of an interactive application, and used as an internal representation before conversion into content generation data.

The term “data structure for content production” refers to a predefined schema, format, or set of fields used to represent elements of interactive content, such as characters, scenes, events, and items, in a manner suitable for automated processing and conversion.

The term “content generation data” refers to data converted from the intermediate data into a format usable by a digital content generation apparatus, such as configuration files, resource definitions, or scene descriptions, that can be directly consumed by content generation tools.

The term “digital content generation apparatus” refers to a software or hardware system configured to generate digital content, such as a content creation engine or an interactive content authoring tool, which can be controlled via data files or programmatic interfaces.

The term “three-dimensional content generation function” refers to a capability of a digital content generation apparatus to generate three-dimensional assets, scenes, or environments, including geometry, textures, lighting, and object placement.

The term “interactive content generation function” refers to a capability of a digital content generation apparatus to generate content that supports user interaction, such as gameplay logic, event triggers, user interface elements, or interactive scenarios.

The term “digital content” refers to electronically stored or generated content elements, such as scenes, assets, configurations, or executable artifacts, that represent at least part of a virtual environment and that can be rendered or executed by an application.

The term “evaluation description information” refers to data generated by the processor that describes components of the digital content and indicates a correspondence relationship between those components and user intention derived from the prompt sentence.

The term “user intention” refers to a semantic or conceptual objective, requirement, or preference expressed by a user through the prompt sentence, including desired settings, narratives, or features of a virtual environment.

The term “comparison evaluation model input data” refers to input data supplied to the generative AI model that includes at least the evaluation description information and the prompt sentence, and that is used to perform comparison and evaluation between user intention and generated digital content.

The term “evaluation result information” refers to data output by the generative AI model that indicates mismatch elements between the user intention and the digital content, and that includes one or more modification proposals for improving the alignment.

The term “mismatch element” refers to a difference, omission, inconsistency, or contradiction between the user intention and the generated digital content, as identified by the generative AI model.

The term “modification proposal” refers to a suggested change, addition, deletion, or adjustment to intermediate data or content generation data that is intended to reduce or eliminate mismatch elements and better align the digital content with user intention.

The term “repeatedly execute regeneration processing” refers to the processor performing multiple cycles of correcting data based on evaluation result information, re-inputting the corrected data to the digital content generation apparatus, and generating updated digital content until a predetermined condition is satisfied.

The term “predetermined condition” refers to a criterion or set of criteria, such as a threshold for evaluation score, a maximum iteration count, or a completion flag, which defines when the repeated regeneration processing is to be terminated.

The term “summary information” refers to data that provides an overview of the final digital content, including at least a description of main components, structure, or characteristics of the virtual environment, for presentation to the user.

The term “display control function” refers to a software component or module operating on the user terminal that generates and manages user interfaces, such as input screens, for acquiring character information from the user.

The term “data communication function” refers to a software or hardware mechanism at the user terminal configured to transmit and receive data via a communication network, including the transmission of character information to the server.

The term “communication network” refers to a wired or wireless data communication infrastructure, such as a local area network or a wide area network, configured to interconnect the user terminal and the server.

The term “batch processing function” refers to a capability of a computing environment to execute one or more programs or commands non-interactively, typically by processing a set of instructions or jobs without direct user intervention.

The term “command-line processing function” refers to a capability of a computing environment to execute programs or scripts based on command-line instructions, arguments, or parameters supplied by another program or process.

The term “external storage device” refers to a storage resource accessible by the digital content generation apparatus and the server, such as a file system, storage medium, or network-attached storage, used to store data files including content generation data.

The term “data file” refers to a structured or semi-structured file stored on a storage device, containing content generation data, configuration data, or other information used by the digital content generation apparatus during content generation.

The term “log information” refers to data that records processing events, messages, errors, or status updates generated by the digital content generation apparatus during execution of a generation process.

The term “status information” refers to data indicating a processing state, result, or progress of operations performed by the digital content generation apparatus, such as success, failure, or intermediate execution states.

In one embodiment, a server cooperates with at least one terminal operated by a user to generate digital content corresponding to a virtual environment. The server includes a processor and a storage device. The processor executes a program stored in the storage device. The program defines multiple functional modules, including a communication module, a prompt management module, a model interface module, a data transformation module, a content generation control module, an evaluation module, and an iteration control module. The terminal includes a display unit, an input unit, a communication unit, and a local storage. The terminal executes a client program such as a web browser or a dedicated application.

The terminal provides an input screen to the user. The terminal uses a graphical user interface framework, for example a hypertext-based framework in a general-purpose browser or a native user interface toolkit in a mobile operating system. The terminal displays at least one text input area for a prompt sentence and a transmission control such as a button. The user operates the input unit of the terminal to enter a natural language prompt sentence. For example, the user enters the following text:

“I want to create a story about a hero fighting a dragon in a medieval fantasy world.” The terminal converts the key input into character code data, encodes the data as a character string such as UTF-8, and stores the string temporarily in the local storage. The terminal then constructs a communication packet that includes the prompt sentence and identification information such as a user identifier. The terminal uses the communication unit and a network protocol such as HTTPS to transmit the packet to the server over a communication network.

The server receives the packet through the communication module. The server may use a web server framework such as a generic HTTP server or an application framework that provides an application programming interface endpoint. The server parses the packet, extracts the prompt sentence and the identification information, and stores the extracted data in the storage device. The storage device may be implemented using a database system such as a relational database or a document-oriented database. The server associates the prompt sentence with user identification information and request identification information. The server allocates a unique request identifier, for example a randomly generated universal identifier, and writes a record that contains the prompt sentence, the user identifier, the request identifier, and a status code.

The server uses the model interface module to prepare model input data for a generative AI model. The generative AI model is executed by an information processing apparatus that may be integrated with the server or connected via a network. The information processing apparatus includes one or more central processing units and one or more accelerators such as graphics processing units. The generative AI model is implemented as a neural network, for example a transformer-based architecture with multiple attention layers, feed-forward layers, and layer normalization. The model uses tokenization to map character sequences of the prompt sentence to integer token sequences. The model uses embedding tables to map tokens to real-valued vectors. The model processes the vectors through attention mechanisms and non-linear activation functions to generate output vectors. The model uses a decoding mechanism to convert the output vectors into structured text or structured data.

The server constructs the model input data by combining the prompt sentence with control information such as a system instruction and a temperature parameter. The server may define a system instruction such as:

“Extract entities, scenes, objects, events, and relationships that are required to construct a virtual environment suitable for an interactive application, and output the result as structured data.”

The server sends the model input data to the information processing apparatus using a network protocol such as HTTPS or a local inter-process communication protocol. The server specifies a particular model identifier corresponding to a trained generative AI model. The information processing apparatus receives the model input data, performs tokenization, and applies the transformer network. During inference, the model multiplies token embeddings with learned weight matrices, computes attention scores, and combines context information across tokens. The model generates output tokens that encode structured information about the virtual environment. The structured information may include fields for world settings, characters, enemies, items, and story elements.

The server receives the output from the generative AI model as analysis result data. The analysis result data may be encoded as a structured text or a structured hierarchy such as key-value pairs. The server uses the data transformation module to parse the analysis result data and to extract entities, scenes, objects, events, and relationships. The server normalizes the extracted elements into an intermediate data representation. The intermediate data representation follows a predefined data structure for interactive content production. For example, the server represents each character as an object with fields for identifier, display name, role, base statistics, and references to scenes. The server represents each scene as an object with fields for identifier, type, associated entities, and environmental parameters.

The server then converts the intermediate data into content generation data in a format usable by a digital content generation apparatus. In one embodiment, the digital content generation apparatus is a content creation engine that supports three-dimensional content generation and interactive content generation. The server generates configuration files or data files that conform to the specification of the content creation engine. For example, the server generates files containing lists of scenes, actors, and interaction triggers with numerical parameters.

The server writes these files to an external storage device accessible by the content creation engine.

The server uses the content generation control module to trigger the content creation engine in a non-interactive mode. The server calls a batch processing interface or a command-line interface of the content creation engine. The server specifies the location of the content generation data files as command-line arguments or configuration parameters. The content creation engine loads the data files, parses the structured data, and automatically generates digital content. The content includes asset definitions, scene layouts, and interaction graphs. The content creation engine writes the generated content to project directories or to compiled artifacts.

The server reads log information and status information output by the content creation engine. The log information includes messages about successful asset generation or error messages for invalid data. The server uses the evaluation module to analyze the generated content. The server constructs evaluation description information that summarizes which components are present in the generated content. For example, the server determines that the generated content includes a hero character instance, a dragon enemy instance, and multiple scenes representing a village, a forest, and a mountain cave. The server also extracts narrative elements and behavior definitions from configuration files.

The server uses the generative AI model again to evaluate the correspondence between the evaluation description information and the user intention as expressed in the original prompt sentence. The server constructs comparison evaluation model input data that includes both the evaluation description information and the prompt sentence. The server provides an instruction to the generative AI model to identify mismatches and to propose corrections. The generative AI model processes this input using the same transformer architecture. The model compares the semantic content of the user intention with the semantic content of the generated content description. The model outputs evaluation result information that indicates mismatch elements and modification proposals. For example, the model may output that the hero's motivation is insufficiently detailed or that an intermediate quest is missing.

The server uses the iteration control module to apply the modification proposals. The server updates the intermediate data or the content generation data. The server may add new entities, modify event sequences, or adjust relationships between scenes and objects according to explicit modification instructions contained in the evaluation result information. The server performs these updates by applying rule-based transformations. For example, the server uses rules to ensure that new identifiers do not collide with existing identifiers and that references between scenes and entities remain consistent. The server writes updated content generation data files and re-invokes the content creation engine via the batch interface. This iteration continues until a predetermined condition is satisfied. The predetermined condition may be defined as an evaluation score exceeding a threshold value, as indicated by numerical scoring in the evaluation result information, or as a maximum iteration count.

The server generates summary information about the final digital content after the iterative process terminates. The server constructs human-readable text that describes the main components of the virtual environment, such as the main character, main antagonist, primary locations, and central story arcs. The server sends the summary information to the terminal via the communication module. The terminal receives the summary information, displays the information on the display unit, and allows the user to review the result. The user may then input additional prompt sentences to refine the content, such as:

“Add a rival knight who also wants to defeat the dragon.”

The server performs the same processing on the additional prompt sentence and integrates new elements into the existing intermediate data.

The described architecture provides a technical improvement to computer technology. The server does not merely display generative AI output to the user. The server uses specific data structures for intermediate data and content generation data, and uses deterministic transformation procedures to ensure that the generative AI output is mapped to engine-ready formats without manual intervention. The combination of structured extraction, schema-based normalization, and automated batch invocation of the content creation engine reduces the amount of human editing and lowers the probability of inconsistent data. As a result, the system improves internal data management by keeping entity identifiers and references consistent across multiple iterations.

The server improves processing speed because the server performs iterative refinement using machine-executed loops rather than user-driven trial and error. The server performs multiple cycles of generation and evaluation without requiring user interaction between cycles. The evaluation module uses the generative AI model to compute mismatch elements, which allows the server to identify specific fields in the intermediate data that require modification. This targeted modification reduces the number of full regenerations and thus reduces computation cost on the content creation engine.

The use of a transformer-based generative AI model contributes to technical improvements because the model can encode long-range dependencies in the prompt sentence and in the evaluation description information. The model uses multi-head attention to focus on different aspects of the prompt sentence and the generated content description simultaneously. This mechanism allows the model to detect subtle mismatches in relationships between characters and scenes, which would be difficult to capture with simple string matching. The model parameters are trained using supervised learning or reinforcement learning with a loss function that penalizes incorrect structure extraction and misaligned content. During training, the model adjusts weights via gradient descent and backpropagation to minimize the loss. The use of such a learned model enables high precision in extraction and comparison tasks, which in turn leads to more accurate intermediate data and fewer corrective iterations.

The server further improves computational efficiency by decoupling natural language processing tasks from engine-specific transformations. The model interface module outputs structured information in a general schema that is independent of a particular content creation engine. The data transformation module then converts this general representation to specific data fields required by a given engine. This modular design allows the server to reuse the same generative AI model for different output targets while keeping transformation logic in separate modules. This reduces the need to retrain models for each engine type, thereby lowering training cost and storage usage.

The system also reduces communication load. The terminal transmits only compact textual prompt sentences and receives summary information as text or small metadata sets. Large asset files and engine-specific content representations remain within the server and the content creation engine environment. Therefore, the communication network is not burdened with repeated transfers of large binary files between the server and the terminal. This architecture improves network utilization and reduces latency for user interaction.

The server uses decision criteria that differ from conventional human workflows. The evaluation module uses the generative AI model to apply a non-human rule set encoded in model weights. The model implicitly learns patterns about what constitutes a coherent virtual environment from training data and uses those patterns to generate modification proposals. For example, the model may always ensure that a final boss encounter is logically preceded by preparatory events and that item distributions across scenes remain balanced. These rules are not simple human-authored instructions but emerge from high-dimensional parameter configurations. The server makes use of this learned structure to update intermediate data in a way that is not a direct automation of manual operations. Instead, the server uses an algorithm that leverages the generative AI model's internal representation space to perform alignment operations that would be computationally complex or inconsistent if executed by hand.

In alternative embodiments, the server may use different types of generative AI models, such as encoder-decoder architectures or recurrent neural networks, as long as the models output structured analysis result data and evaluation result information in response to prompt sentences and evaluation description information. The server may implement the data transformation module using different programming languages or different serialization formats, such as binary formats for high-performance engines. The content creation engine may be replaced by a different interactive content generation apparatus, such as a virtual reality authoring platform or an augmented reality framework, provided that the apparatus can be driven via content generation data supplied by the server.

In another embodiment, the server may operate with multiple terminals and manage parallel requests. The server schedules model inference calls and engine invocations to optimize utilization of computational resources, for example by batching multiple model input data instances for parallel inference on a graphics processing unit. The server may also compress content generation data files before writing them to the external storage device to reduce disk usage and improve file transfer times between the server and the content creation engine.

In yet another embodiment, the server may maintain a history of intermediate data and evaluation result information. The server can analyze this history to adjust transformation rules and to improve subsequent automatic corrections. For example, the server may detect that certain types of mismatch elements occur frequently and update rule parameters to avoid those mismatches in earlier stages of the pipeline. This feedback into the rule system provides an additional improvement to computational efficiency and content quality.

Through these embodiments, the server, the terminal, and the user cooperate to implement the claimed system in a manner that improves computer functionality, reduces manual intervention, enhances data consistency, and increases the speed and precision of generating digital content corresponding to virtual environments based on natural language prompt sentences.

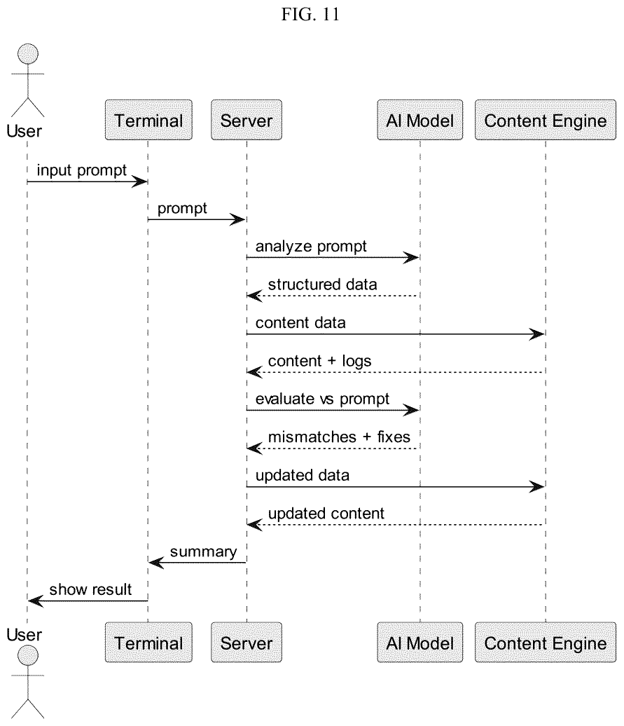

The following describes the processing flow using FIG. 11.

### Step 1:

The user operates the terminal to launch a client application or web browser and to display an input screen. The terminal presents a text input field and a send button on the display unit.

The user inputs a prompt sentence, for example, “I want to create a story about a hero fighting a dragon in a medieval fantasy world.” as text through the input unit. The terminal receives the keystrokes as input, converts them into a character string encoded in UTF-8, and generates a data structure that includes the prompt sentence and local user identification. The output of this step is a character string containing the prompt sentence and associated local metadata stored temporarily in the terminal.

### Step 2:

The terminal uses the communication unit to transmit the prompt sentence and metadata to the server via a network. The terminal constructs a request payload, for example a JSON object that includes the prompt sentence and user identification, and encapsulates this payload in an HTTPS request. The input of this step is the locally stored character string and metadata; the terminal performs serialization and encryption at the transport layer, and the output is an HTTPS request containing the serialized prompt data sent over the communication network to the server.

### Step 3:

The server receives the HTTPS request from the terminal through a communication module. The server parses the HTTP headers and body to extract the prompt sentence and user identification information. The server generates a unique request identifier, associates it with the user identification, and writes a record into a storage device using a database system. The input of this step is the serialized request payload; the server performs parsing, identifier generation, and database insertion operations, and the output is a persistent record that links the prompt sentence with the user and a request identifier.

### Step 4:

The server prepares model input data for a generative AI model. The server reads the stored prompt sentence and combines it with control parameters such as a system instruction, maximum token length, and a temperature value. The server formats this combination into a structure expected by the generative AI model, for example a sequence of role-tagged text segments. The input of this step is the prompt sentence and identification record retrieved from the storage device; the server performs string concatenation, parameter attachment, and structural formatting, and the output is model input data suitable for submission to the generative AI model.

### Step 5:

The server invokes an information processing apparatus that executes the generative AI model. The server sends the model input data to the apparatus via an application programming interface over a secure channel. The information processing apparatus receives the model input data, tokenizes the prompt sentence into a sequence of token identifiers, maps the identifiers to embedding vectors using learned embedding matrices, and processes the vectors through a transformer network including multi-head attention layers and feed-forward layers. The apparatus computes attention weights, performs matrix multiplications with learned weight parameters, and generates output vectors representing structured information. The apparatus decodes the output vectors into structured analysis result data, for example text that describes entities, scenes, objects, events, and relationships. The input of this step is the model input data; the server and apparatus perform tokenization, neural network inference, and decoding, and the output is analysis result data transmitted back to the server.

### Step 6:

The server receives the analysis result data from the generative AI model. The server parses the structured output and converts it into internal data objects that correspond to elements of a virtual environment, such as character objects, scene objects, and item objects. The server validates the presence of required fields, normalizes naming conventions, and resolves simple inconsistencies. The input of this step is the structured analysis result text or data; the server performs parsing, validation, and normalization, and the output is a set of internal intermediate data objects stored in the storage device.

### Step 7:

The server transforms the intermediate data objects into engine-agnostic intermediate data representations following a predefined schema. The server assigns unique identifiers to each entity and scene, computes default numeric values for missing parameters (such as health points or attack power), and establishes reference links between data objects, for example linking a character to a home scene or linking a quest event to a location. The input of this step is the parsed intermediate data objects; the server performs identifier assignment, default-value computation, and reference linking, and the output is a normalized intermediate data set that conforms to the interactive content production data structure.

### Step 8:

The server converts the normalized intermediate data into content generation data specific to a digital content generation apparatus. The server maps generic field names to engine-specific field names, converts enumerated types to engine-specific codes, and writes configuration information into data files such as structured text files. The input of this step is the normalized intermediate data; the server performs field mapping, value transformation, and file generation, and the output is a collection of content generation data files stored on an external storage device accessible by the content generation apparatus.

### Step 9:

The server controls the digital content generation apparatus using a batch or command-line interface. The server constructs a command that includes the path to the content generation data files and executes the command on a machine where the content generation apparatus is installed. The content generation apparatus loads the data files, parses the content generation data, and creates digital content assets including scenes, characters, and interaction logic. The input of this step is the content generation data files and the control command; the content generation apparatus performs file reading, asset creation algorithms, and scene layout computation, and the output is generated digital content stored as project assets and log information written to log files.

### Step 10:

The server obtains execution results from the digital content generation apparatus. The server reads log information and status information produced during asset generation and verifies whether the content generation completed successfully. The server also reads metadata or summary files generated by the apparatus to determine which assets and scenes were created. The input of this step is the log files, status codes, and metadata files; the server performs file reading, string parsing, and status evaluation, and the output is an internal representation of the generated digital content components and a success or failure status.

### Step 11:

The server generates evaluation description information that summarizes the generated digital content in relation to the original prompt sentence. The server enumerates the components of the digital content, such as the hero character, dragon enemy, and specific locations, and represents them as descriptive text or structured data aligned with the terminology used in the prompt sentence. The input of this step is the internal representation of generated components and the original prompt sentence; the server performs component extraction, description generation, and correlation with prompt terms, and the output is evaluation description information prepared for comparison with user intention.

### Step 12:

The server prepares comparison evaluation model input data for the generative AI model. The server combines the evaluation description information and the original prompt sentence with an instruction that requests identification of mismatches and suggestions for improvement. The server formats this combination in the input structure required by the generative AI model. The input of this step is the evaluation description information and the original prompt sentence; the server performs text concatenation, role assignment, and structural encoding, and the output is comparison evaluation model input data ready for submission to the generative AI model.

### Step 13:

The server submits the comparison evaluation model input data to the generative AI model via the information processing apparatus. The apparatus tokenizes both the prompt sentence and the evaluation description information, embeds tokens, and processes the combined sequence through the transformer network. The apparatus computes context-aware representations that capture relationships between user intention and generated content. The apparatus decodes the output vectors into evaluation result information, which includes explicit mismatch elements and modification proposals. The input of this step is the comparison evaluation model input data; the apparatus performs neural network inference and output decoding, and the output is evaluation result information returned to the server.

### Step 14:

The server interprets the evaluation result information and determines which parts of the intermediate data or content generation data require modification. The server parses the modification proposals to identify actions such as adding new entities, changing relationships, or adjusting event sequences. The server applies rule-based update operations to the intermediate data, for example inserting a new rival character with specified attributes or adding a preparatory quest before a boss battle. The input of this step is the evaluation result information and the existing intermediate data; the server performs parsing, rule evaluation, and data modification, and the output is an updated intermediate data set reflecting the proposed corrections.

### Step 15:

The server regenerates updated content generation data from the modified intermediate data. The server repeats the transformation and file generation operations used previously, but only for affected parts when possible, in order to reduce processing overhead. The input of this step is the updated intermediate data; the server performs selective field mapping, file overwriting or creation, and integrity checks, and the output is revised content generation data files that incorporate the modifications.

### Step 16:

The server re-invokes the digital content generation apparatus using the revised content generation data. The server executes a new batch or command-line command that instructs the apparatus to update or recreate specific assets and scenes. The digital content generation apparatus loads the revised data files, performs incremental or full regeneration of digital content, and outputs updated log and status information. The input of this step is the revised content generation data and control command; the apparatus performs regeneration algorithms, and the output is updated digital content and new execution records.

### Step 17:

The server determines whether a predetermined termination condition has been satisfied. The server may analyze quantitative scores contained in the evaluation result information, count the number of refinement iterations, or check for the absence of mismatch elements. The input of this step is the most recent evaluation result information and iteration metadata; the server performs comparison operations and threshold checks, and the output is a decision indicating either continuation of the iteration loop or completion of the process.

### Step 18:

The server generates final summary information when the termination condition is satisfied. The server composes a clear description of the resulting virtual environment, including key characters, important locations, major events, and narrative structure, and optionally includes links or identifiers for the generated digital content artifacts. The input of this step is the final intermediate data and the final representation of generated content; the server performs summarization, text generation, and data aggregation, and the output is human-readable summary information.

### Step 19:

The server transmits the final summary information to the terminal. The server packages the summary information into a response payload, for example as structured text, and sends it via HTTPS to the terminal. The terminal receives the payload through the communication unit, parses the content, and displays the summary on the display unit as a readable report. The input of this step on the server side is the summary information; the server performs serialization and network transmission, and the output is a network response. On the terminal side, the input is the received response; the terminal performs parsing and rendering, and the output is a visual presentation that allows the user to review the generated virtual environment based on the original prompt sentence.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional tools for creating virtual environments and interactive digital content typically require manual authoring of narrative structures, characters, and interaction logic using specialized editing interfaces and scripting languages. Even when such tools are combined with a generative AI model, the integration is often limited to one-shot text generation that produces unstructured narrative descriptions. As a result, a human creator must still interpret the generated text, manually decompose it into design elements, and manually configure a content generation engine. This causes significant latency between a creator's idea and a playable prototype, increases cognitive load on the creator, and requires substantial technical expertise in content authoring tools.

Furthermore, existing systems generally do not provide an iterative, closed feedback loop between a user's evaluation of a playable prototype and the generative AI model. Feedback is often applied in an ad hoc manner, and there is no systematic mechanism for converting user evaluations and correction requests into machine-readable, structured updates that can be re-applied to the content generation engine. This leads to fragmented version control of the game design, duplicated work when changes are requested, and difficulty in maintaining consistency across narrative, character behavior, and interaction logic.

In addition, the process of publishing an interactively generated virtual environment to a content distribution platform is typically disconnected from the content generation pipeline. A creator must export builds manually, prepare metadata separately, and interact with distribution tools that are not aware of the underlying design structure generated by the AI model. This disconnection hinders automation, introduces opportunities for configuration errors, and delays deployment of the final content to end users.

Therefore, there is a need for a computer-implemented system that technically improves the way virtual environments are generated, revised, and deployed by: (i) tightly coupling a generative AI model with a structured intermediate representation that is directly consumable by a digital content generation apparatus; (ii) establishing an automated, iterative feedback loop in which user evaluation and correction requests are converted into additional prompt sentences and partial updates of the intermediate representation; and (iii) integrating automated generation of publication information for a content distribution platform based on the same structured data. Such a system can reduce manual intervention, lower the required level of technical expertise, and improve the efficiency, consistency, and responsiveness of the overall content creation pipeline at the level of computer system operation.

The specific processing by the specific processing unit 290 of the data processing device 12 in Application Example 1 is realized by the following means.

The present invention provides a server comprising a processor configured to receive, from a user operation terminal, a prompt sentence describing a desired virtual environment, to input the prompt sentence into a generative AI model, and to cause the generative AI model to analyze, based on instruction information including the prompt sentence, a world setting, actors, action objectives, and progression structure of the virtual environment; to convert the world setting, the actors, the action objectives, and the progression structure obtained from the generative AI model into intermediate structured information in a machine-readable format, to automatically generate, based on the intermediate structured information, setting information and control information for a digital content generation apparatus, and to transmit the setting information and the control information to the digital content generation apparatus so as to cause the digital content generation apparatus to construct a prototype of an interactive virtual environment; to acquire, via the user operation terminal, evaluation information and correction requests from a user for the prototype constructed by the digital content generation apparatus, to input, into the generative AI model, an additional prompt sentence including the evaluation information and the correction requests, to partially update the intermediate structured information based on an output of the generative AI model, and to regenerate, based on the updated intermediate structured information, the setting information and the control information for the digital content generation apparatus so as to iteratively update the prototype; and to generate distribution information for causing a content distribution platform to publish a final version of the interactive virtual environment generated by the digital content generation apparatus and explanatory information of the interactive virtual environment in response to an approval of the prototype from the user, and to transmit the distribution information to the content distribution platform. This enables a technical improvement in computer-implemented content generation by automatically transforming natural-language prompt sentences and user feedback into structured, engine-ready data, maintaining an iterative feedback loop that updates prototypes with reduced manual intervention, and integrating automated publication to a content distribution platform based on a unified intermediate representation, thereby enhancing the efficiency, consistency, and responsiveness of virtual environment creation and deployment at the system level.

The term “processor” refers to one or more hardware processing units or processing circuits, such as a central processing unit or graphics processing unit, that execute instructions to perform operations on data within the system.

The term “user operation terminal” refers to an electronic device operated by a user, such as a computing device including an input interface and a display interface, that transmits prompt sentences, feedback, and control instructions to the server and receives prototype information and publication information from the server.

The term “prompt sentence” refers to a natural-language or structured text string provided by a user through the user operation terminal, which describes a desired virtual environment, including at least part of a world setting, actors, action objectives, progression structure, or modifications thereto, and which is used as an input to a generative AI model.

The term “additional prompt sentence” refers to a prompt sentence that includes evaluation information and correction requests for a previously generated prototype of a virtual environment, and that is provided to a generative AI model to update or refine an existing design.

The term “generative AI model” refers to a machine learning model having a generative function, such as a generative learning model with a natural language processing capability, that receives a prompt sentence as input and outputs information describing a virtual environment, including at least a world setting, actors, action objectives, progression structure, or dialogue information.

The term “instruction information” refers to information that includes a prompt sentence and optionally includes system-level constraints, formatting requirements, or generation conditions, and that is provided to the generative AI model to control the analysis and generation of virtual environment information.

The term “virtual environment” refers to a computer-generated environment, including at least one virtual space, one or more actors, and associated interaction logic, which is presented to a user as digital content and can be experienced interactively.

The term “world setting” refers to information defining the overall context of a virtual environment, including at least spatial, temporal, thematic, or rule-related aspects that characterize the environment in which actors operate.

The term “actor” refers to an entity that exists within a virtual environment and can participate in interactions, including at least playable characters, non-playable characters, opponents, allies, or other interactive objects.

The term “actor attribute” refers to information associated with an actor, including at least a name, role, capabilities, status parameters, behavioral tendencies, or relationships with other actors.

The term “action objective” refers to a goal or task that an actor or a user is intended to achieve within a virtual environment, including at least mission objectives, quest goals, or conditions for progression.

The term “progression structure” refers to information defining how events, scenes, or stages of a virtual environment are ordered, branched, or unlocked over time, including at least sequences of levels, quests, episodes, or narrative segments.

The term “dialogue information” refers to text or structured data representing verbal exchanges or narrative lines between actors or between an actor and the user within a virtual environment.

The term “intermediate structured information” refers to machine-readable data derived from the output of the generative AI model, representing elements such as the world setting, actors, actor attributes, action objectives, progression structure, and dialogue information in a structured format suitable for automatic processing by a digital content generation apparatus.

The term “code information” refers to program code or script data generated based on intermediate structured information, which is configured to be executed or interpreted by a digital content generation apparatus to implement behavior, logic, or interaction within a virtual environment.

The term “configuration information” refers to non-executable data files or parameters, including at least resource references, placement information, relationship definitions, and control parameters, that are generated based on intermediate structured information and are used by a digital content generation apparatus to construct a virtual environment.

The term “setting information” refers to information that defines configuration states or properties of components within a digital content generation apparatus, including at least scene settings, object parameters, and environment parameters, which are derived from intermediate structured information.

The term “control information” refers to information that configures operational logic, interaction handling, or event processing within a digital content generation apparatus, including at least scripts, state machines, or rule sets that control an interactive virtual environment.

The term “digital content generation apparatus” refers to a computing system, including at least one software engine and associated tools, configured to generate or assemble digital content, such as a virtual environment, based on setting information, control information, code information, and configuration information.

The term “content generation engine” refers to a software engine that forms part of a digital content generation apparatus, and that is capable of automatically configuring, rendering, and executing interactive content, including at least arranging virtual spaces, actors, and interaction control processing based on intermediate structured information.

The term “three-dimensional interactive content” refers to digital content that presents a three-dimensional virtual space and allows user interaction with actors or objects within that space in real time or near real time.

The term “prototype of an interactive virtual environment” refers to a preliminary version of a virtual environment generated by a digital content generation apparatus, which implements at least part of the intended world setting, actors, action objectives, and progression structure, and which is suitable for evaluation and testing by a user.

The term “evaluation information” refers to information representing a user's assessment of a prototype of an interactive virtual environment, including at least qualitative comments, ratings, or indications of parts to be improved or changed.

The term “correction request” refers to information representing a user's explicit request to modify one or more aspects of a prototype of an interactive virtual environment, including at least changes to actor attributes, story tone, objectives, or progression structure.

The term “iteratively update” refers to repeatedly modifying and regenerating a prototype of an interactive virtual environment by applying updated intermediate structured information produced in multiple cycles of receiving user feedback and using a generative AI model.

The term “explanatory information” refers to descriptive information about a virtual environment, including at least a title, synopsis, feature description, or usage instructions, which can be used for presentation on a content distribution platform or within a user interface.

The term “distribution information” refers to information generated for causing a content distribution platform to publish a virtual environment, including at least identifiers of executable content, metadata describing the content, access control parameters, and references to explanatory information.

The term “content distribution platform” refers to an electronic service or system configured to host, manage, and provide access to digital content to end users, including at least a server system and associated software that can receive distribution information and make a virtual environment available for download or streaming.

The term “machine-readable format” refers to a representation of information that can be automatically processed by a computing device, including at least structured formats such as a markup format, a data-interchange format, or serialized object data.

The term “generative learning model” refers to a machine learning model that is trained to generate new data samples, including at least text, based on learned patterns from training data, and that can produce outputs such as world settings, actors, or dialogue information in response to prompt sentences.

The term “natural language processing function” refers to a capability of a model or system to analyze, understand, and generate human language expressions, including at least tokenization, semantic analysis, and text generation from prompt sentences.

In one embodiment, a system includes a server and at least one terminal connected via a communication network. The server includes a processor, a memory, a non-transitory storage device, and a communication interface. The terminal includes a processor, a memory, a display device, at least one input device, and a communication interface. The terminal operates under a general-purpose operating system, such as a mobile operating system or a desktop operating system, and executes a client application. The server operates under a server operating system and executes a backend application including a generative AI model execution module, a data transformation module, a content generation interface module, and a publication management module.

The terminal executes the client application to provide a graphical user interface that allows the user to input a prompt sentence describing a desired virtual environment. The terminal uses a display panel to show input fields and uses an input device, such as a touch screen, keyboard, or microphone, to capture user input. When the user inputs text, the terminal stores the text in a text buffer in memory. When the user speaks into a microphone, the terminal converts an analog audio signal into a digital signal using an audio codec, and uses a speech-to-text software component to transform the digital audio into text characters. The terminal then stores the text characters as a prompt sentence.

The terminal encodes the prompt sentence as character data in a predetermined character encoding format and attaches metadata such as user identifier, project identifier, and language identifier. The terminal uses a communication interface to establish a secure channel with the server using a transport layer security protocol and transmits the encoded prompt sentence and metadata to the server as a data packet. The server receives the data packet via the communication interface and writes the packet to an input buffer in memory.

The server parses the received data packet, extracts the prompt sentence and associated metadata, and stores them in a structured data store managed by a database management system. The server assigns an internal design identifier to the prompt sentence and creates initial records for world settings, actors, objectives, and progression structures as empty or placeholder entries linked to the design identifier. This database organization allows the server to manage versions of design data and to apply iterative updates efficiently.

The server uses a generative AI model to transform the prompt sentence into detailed design data. In one embodiment, the generative AI model is implemented as a transformer-based neural network that uses multi-head self-attention layers, feedforward layers, and layer normalization. The server performs tokenization on the prompt sentence using a subword-based tokenizer to convert the prompt sentence into a sequence of token indices. The server stores this token sequence in a model input buffer and applies an embedding matrix to convert token indices into dense vectors. The server then propagates these vectors through multiple transformer layers, where each layer computes attention weights and context-aware representations.

The server configures the generative AI model with specific hyperparameters, such as number of layers, attention heads, hidden dimension size, and vocabulary size. The server uses a learned positional encoding to preserve token order and uses a softmax function in the attention mechanism to compute probability distributions over token positions. During inference, the server uses a decoding algorithm, such as greedy decoding or top-p sampling with a defined threshold, to generate output token sequences representing a structured description of the virtual environment.

The server decodes the output token sequences into text and then applies a post-processing module to convert the text into intermediate structured information. In one embodiment, the generative AI model is trained to output data in a structured text format that includes explicit markers for elements such as “WORLD_SETTING:”, “MAIN_ACTOR:”, “OBJECTIVE:”, “LEVEL_SEQUENCE:”, and “DIALOGUE:”. The server uses a parser to detect these markers and segment the output text into fields. The server then maps the segmented text into a hierarchy of objects in memory, representing a world object, actor objects, objective objects, and progression nodes.

The server stores these objects as intermediate structured information in a machine-readable format, such as a key-value structure or a tree structure, within the database. The server assigns unique identifiers to each entity and maintains relational associations among entities. This specific data structure allows the server to regenerate only affected portions of a virtual environment when updates are received, thereby improving computational efficiency and reducing redundant processing.

The server then uses the intermediate structured information to generate engine-ready data for a digital content generation apparatus. In one embodiment, the digital content generation apparatus is a game engine that can be controlled via configuration files and script files. The server uses a template-based generator to transform the world object, actor objects, and progression nodes into multiple data artifacts, such as configuration descriptors, script stubs, and asset mapping files. For example, the server generates configuration descriptors for each virtual space, including parameters such as spatial layout references, lighting presets, and interaction trigger definitions. The server also generates data describing each actor, including behavior parameters, interaction rules, and dialogue lines.

The server uses a rule-based mapping algorithm to convert abstract design elements into engine-specific constructs. For example, the server maps a progression node describing “training phase”, “journey”, and “final battle” into separate scene definitions and connecting transitions. The server writes these files into a directory structure accessible by the digital content generation apparatus. This transformation is not a simple textual copy; the server applies constraints, validates references, and ensures that each generated file conforms to a predefined schema that the engine can parse efficiently. As a result, the digital content generation apparatus can load and assemble complex interactive content using a consistent and automated procedure.

The server then instructs the digital content generation apparatus to construct a prototype of an interactive virtual environment. The server transmits references to the generated files and target platform parameters to the digital content generation apparatus via an application programming interface. The digital content generation apparatus loads the configuration files, instantiates virtual spaces, spawns actor objects in designated locations, and binds scripts and control logic to each object. The digital content generation apparatus then produces a packaged prototype, such as a binary executable or a web-based build. The server receives a prototype identifier or location from the digital content generation apparatus and stores this in association with the design identifier.

The terminal receives information about the prototype from the server and provides a user interface for accessing and playing the prototype. The terminal downloads or streams the prototype data, depending on the packaging format, and invokes an appropriate runtime module to execute the prototype. For a three-dimensional interactive environment, the terminal uses its graphics hardware to render scenes and uses its input devices to capture user commands. The terminal transmits user interaction data, such as control events and play duration, to the server for logging and analysis.

The user evaluates the prototype by experiencing the interactive virtual environment on the terminal. The user identifies desired changes, such as altering the main character's name, modifying the story tone, or adding new quests. The terminal presents a feedback interface through which the user inputs descriptive feedback in natural language. The user may enter an additional prompt sentence such as:

“I want to create a story about a hero fighting a dragon in a medieval fantasy world.” or

“Change the hero's name to ‘Aria’, make the tone darker, and add a side quest where Aria rescues a captured mage from the forest.”

The terminal captures these additional prompt sentences, packages them with prototype identifiers and entity references, and transmits them to the server. The server receives the additional prompt sentences, retrieves the corresponding intermediate structured information from the database, and constructs an augmented input for the generative AI model. The server concatenates a summarized representation of the existing design with the additional prompt sentence and includes explicit instructions to modify only specified elements. This instruction data is then tokenized and processed by the same generative AI model.

The server uses a constrained generation strategy to obtain partial updates. In one embodiment, the server provides a mask or annotation indicating which fields are eligible for modification, such as actor name, tone descriptors, or quest list. The generative AI model is trained or fine-tuned to respect these constraints and to output only updated segments, reducing unnecessary changes. This architecture differs from conventional systems that regenerate entire narratives; it allows the server to minimize changes and maintain consistency, leading to reduced recomputation and communication overhead.

The server parses the generative AI model's output and merges updated information into the existing intermediate structured information. The server applies a conflict resolution algorithm that compares old and new values for each field and only overwrites fields that are explicitly marked as changed. The server updates database records with the new actor name, adjusted tone parameters, and additional quest objects. This selective update process reduces database write operations and contributes to improved performance, particularly for large designs.

The server then regenerates only those engine-ready data files that are affected by the updated intermediate structured information. For example, if only the main actor's name and certain dialogues have changed, the server regenerates character description files and dialogue scripts while leaving unchanged scene configurations intact. This selective regeneration reduces build time and decreases I/O load on storage devices. The digital content generation apparatus receives updated configuration files and rebuilds or reloads only relevant parts of the prototype. This approach leads to faster turnaround for iterative testing and provides a direct technical improvement in build efficiency.

The server also manages generation of distribution information for publishing a final version of the interactive virtual environment. When the user indicates, through the terminal, that a particular prototype version is approved as a final version, the server collects metadata stored in the intermediate structured information, such as world setting summary, main actor description, and objectives. The server uses this metadata to automatically produce explanatory information, including a title, a short description, and feature highlights. The server packages this explanatory information with identifiers for the final prototype build and constructs distribution information that conforms to an application programming interface of a content distribution platform.

The server transmits the distribution information, including references to the final build and associated metadata, to the content distribution platform. The content distribution platform registers the virtual environment as a distributable item and exposes it through its user interface. The server then stores platform-specific identifiers, such as content IDs or URLs, so that the terminal can later display links to the published content. This automatic publication process reduces manual configuration errors and speeds up deployment to end users.

The described system provides specific technical improvements in computer operation. By using an intermediate structured information layer between natural-language prompt sentences and engine-specific configuration files, the server reduces the need for repeated full regeneration and rebuild, which improves processing speed and reduces storage access. The selective update mechanism based on partial outputs from the generative AI model and constrained regeneration reduces unnecessary computation and network transmission, contributing to lower communication load. The structured approach also improves data management by providing a consistent schema for design elements, allowing faster queries and safer updates.

The generative AI model itself is implemented with a specific architecture and training procedure that contribute to technical effects. The server trains the transformer-based model on pairs of prompt sentences and structured design representations. During training, the server uses a loss function such as cross-entropy between predicted tokens and ground-truth tokens, and applies gradient-based optimization, such as stochastic gradient descent or an adaptive method, to update model weights. The server may perform data augmentation by rephrasing prompt sentences and varying narrative details, improving model robustness to diverse inputs. The attention-based architecture allows the model to capture long-range dependencies in narrative structure, which leads to more coherent world settings and progression structures compared to simpler models.

The server uses this trained model in a way that is not a mere automation of human drafting. Instead of generating plain text that a human editor must interpret, the server generates content aligned with specific markers and schemas that directly match machine-readable fields. This non-conventional usage of generative AI-combined with structured parsing and constrained update rules-enables automated control of a digital content generation apparatus that would be impractical to achieve manually. In addition, the system's iterative loop uses machine-readable deltas rather than full re-authoring, thereby creating a feedback cycle that optimizes computational resources.

In another embodiment, the server uses a variant generative AI model specialized for dialogue generation, separate from a model specialized for structural progression. The server first applies a structural model to derive world settings and progression structures, and then applies a dialogue model to fill in character dialogues consistent with the structural output. The server synchronizes these models by passing entity identifiers and role information between them, maintaining referential integrity in the intermediate structured information. This modular configuration allows the server to scale to larger virtual environments by distributing workload between specialized models.

In yet another embodiment, the terminal is implemented as a head-mounted display device with motion sensors, and the prototype of the interactive virtual environment is executed in an immersive mode. The terminal transmits additional sensor data, such as head orientation and position, to the digital content generation apparatus, which uses these data to adjust camera orientation and interaction triggers. The server can record these usage patterns as part of evaluation information and reflect them, through additional prompt sentences, into layout adjustments or interaction complexity changes. Thus, the system can adapt not only narrative and structural content, but also spatial and interaction parameters, providing a broader technical effect on runtime behavior.

The system can also be implemented with alternative data stores, such as document-oriented databases or graph databases, while maintaining the same intermediate structured information logic. The server can represent entities and their relationships as nodes and edges in a graph, which can be efficiently traversed to compute affected areas during partial updates. This representation allows the server to minimize regeneration by identifying connected subgraphs that require changes, thereby further reducing computation.

Across these embodiments, the server, the terminal, and the digital content generation apparatus cooperate to implement a pipeline where natural-language prompt sentences are transformed into structured, executable representations of virtual environments. The server manages complex data structures, orchestrates specialized neural network models, and coordinates with a content generation engine and a content distribution platform. As a result, the system improves the efficiency, consistency, and performance of computer-based content creation beyond simple automation of human tasks, and provides a concrete technological solution that enhances how computers process, transform, and deploy interactive virtual environments.

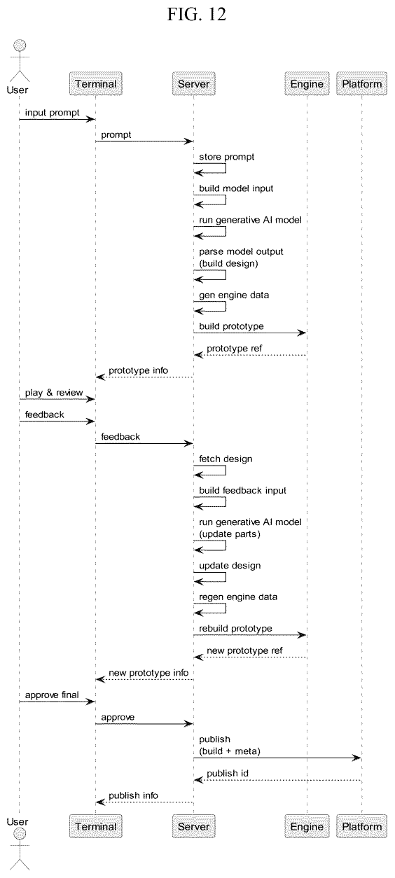

The following describes the processing flow using FIG. 12.

### Step 1:

The terminal displays a creation screen and receives a prompt sentence from the user.

The user operates an input device of the terminal to type or dictate a natural-language description of a desired virtual environment, such as “I want to create a story about a hero fighting a dragon in a medieval fantasy world.”

The terminal, when receiving voice input, converts an analog audio signal into digital audio data, processes the audio data with a speech-to-text component, and outputs a character string.

The terminal, when receiving text input, stores key events in a text buffer and outputs a completed prompt sentence string when the user presses a confirmation control.

The input of this step is raw user input (keystrokes or audio samples), and the output of this step is a finalized prompt sentence represented as encoded text data in a memory buffer of the terminal.

### Step 2:

The terminal generates a request payload including the prompt sentence and metadata, and transmits the payload to the server.

The terminal converts the prompt sentence into a standardized character encoding, attaches identifiers such as user ID and project ID, and embeds these values into a structured message.

The terminal performs data processing by serializing the structured message into a request body, establishing a secure network session with the server, and encapsulating the serialized data into a network packet.

The input of this step is the prompt sentence string and local metadata, and the output of this step is a transmitted request packet containing the prompt sentence delivered to the server via the communication interface.

### Step 3:

The server receives and parses the request containing the prompt sentence.

The server reads the incoming network packet from a communication buffer, verifies protocol headers, and extracts the request body.

The server deserializes the request body into a structured object, thereby recovering the prompt sentence, user identifier, and project identifier as separate fields.

The server performs data processing by validating the length and character set of the prompt sentence and generating a new design identifier if one is not yet associated with the project identifier.

The input of this step is the network request containing the prompt sentence, and the output of this step is a validated data structure representing the prompt sentence and associated identifiers stored temporarily in server memory.

### Step 4:

The server stores the prompt sentence and initializes design records in a persistent data store.

The server maps the prompt sentence and identifiers to relational or document-oriented database fields and executes database write operations.

The server performs data processing by creating or updating records for a design entity, setting initial default values for world settings, actors, objectives, and progression structures, and linking these records to the design identifier.

The input of this step is the structured in-memory representation of the prompt sentence and identifiers, and the output of this step is a set of persistent database records that associate the prompt sentence with a new or existing design.

### Step 5:

The server prepares input data for the generative AI model based on the prompt sentence.

The server constructs an instruction string that combines the prompt sentence with system-level guidance, such as “Analyze the following prompt sentence and output world setting, actors, objectives, progression structure, and dialogue information.”

The server performs data processing by tokenizing the instruction string into a sequence of integer token IDs using a tokenizer associated with the generative AI model, computing the sequence length, and truncating or segmenting the input if it exceeds a predefined token limit.

The input of this step is the raw prompt sentence and configuration parameters for model use, and the output of this step is a tokenized model input sequence stored in a model input buffer.

### Step 6:

The server executes the generative AI model to generate descriptive data for the virtual environment.

The server passes the tokenized input sequence into a neural network model that includes embedding layers, multiple attention layers, feedforward layers, and output projection layers.

The server performs data processing by computing embedding vectors, applying attention mechanisms to calculate context-aware representations, and iteratively generating output token probabilities, then sampling or selecting output tokens according to specified decoding parameters.

The server converts the output token sequence into text, forming a model-generated description that includes world setting details, actor descriptions, objectives, progression structures, and dialogue segments.

The input of this step is the tokenized instruction sequence, and the output of this step is a generated text block that encodes structured information about the virtual environment.

### Step 7:

The server parses the generated text block into intermediate structured information.

The server scans the generated text for structural markers or patterns that delimit sections such as “WORLD_SETTING”, “MAIN_ACTOR”, “OBJECTIVES”, and “LEVELS”.

The server performs data processing by splitting the generated text into segments based on these markers, trimming extraneous characters, and mapping each segment into fields of an internal object model representing world objects, actor objects, and progression nodes.

The server constructs an intermediate graph or tree of entities, assigns identifiers to each entity, and stores attribute values, such as names, roles, and narrative descriptions, in a normalized form.

The input of this step is the unstructured generated text, and the output of this step is intermediate structured information represented as machine-readable objects in server memory.

### Step 8:

The server persists the intermediate structured information into the database.

The server translates each object and its relationships into database-level records and executes insert or update operations.

The server performs data processing by generating foreign key relationships or reference links between records, enforcing constraints, and recording timestamps and version numbers for later retrieval and comparison.

The input of this step is the in-memory intermediate structured information, and the output of this step is a consistent set of stored design entities that reflect the generated world setting, actors, objectives, and progression structure.

### Step 9:

The server transforms the intermediate structured information into engine-ready configuration and code data for a digital content generation apparatus.

The server selects templates corresponding to virtual spaces, actor behaviors, and interaction rules and populates these templates with values from the intermediate structured information.

The server performs data processing by mapping abstract design attributes to specific parameters, such as scene identifiers, spawn positions, script hook names, and dialogue resource keys, and then serializing the filled templates into configuration files and script files.

The input of this step is the structured design data from the database, and the output of this step is a set of engine-ready configuration data and associated script data stored in a project directory accessible by the content generation apparatus.

### Step 10:

The server invokes the digital content generation apparatus to construct a prototype of the interactive virtual environment.

The server passes paths to the generated configuration and script files, along with build target parameters, to the content generation apparatus via a control interface.

The server performs data processing by monitoring status messages and logs emitted by the apparatus, collecting error codes, and determining whether the build process succeeds or fails.

The content generation apparatus reads the configuration files, instantiates scenes, places actor objects, and binds scripts according to the provided data to create an executable prototype build.

The input of this step is the engine-ready configuration and scripts, and the output of this step is a prototype artifact, such as a build file or a deployable package, and a reference identifier for that prototype stored by the server.

### Step 11:

The server notifies the terminal of the availability of the prototype and provides access information.

The server constructs a response message that includes the prototype identifier, a download or streaming location, and summary metadata such as title and main actor name derived from the design data.

The server performs data processing by serializing this information into a response structure and transmitting it to the terminal over the network.

The terminal receives the response, parses the structure, and updates its local state to register the association between the current project and the prototype reference.

The input of this step is the prototype reference and associated metadata in server memory, and the output of this step is a delivered response that enables the terminal to access and execute the prototype.

### Step 12:

The terminal presents the prototype to the user and captures evaluation information.

The terminal downloads or streams the prototype using the provided access information and starts a runtime module to execute the interactive virtual environment.

The user operates input devices to interact with the prototype, experiences the environment, and decides which aspects require change, such as story elements, character attributes, or difficulty level.

The terminal displays a feedback input interface and records user-entered evaluation text and change requests, optionally including additional prompt sentences, for example, “Change the hero's name to Aria, make the tone darker, and add a side quest where Aria rescues a captured mage from the forest.”

The terminal performs data processing by combining free-text feedback with internal references to specific entities and prototype versions and storing them as a feedback object in memory.

The input of this step is the prototype execution and user interactions, and the output of this step is structured feedback data that includes evaluation information and correction requests.

### Step 13:

The terminal transmits the feedback data, including additional prompt sentences, to the server.

The terminal serializes the feedback object into a message structure containing the design identifier, prototype identifier, and textual feedback or additional prompt sentences.

The terminal sends this message through a secure network channel to the server.

The server receives the message, parses it, and extracts evaluation information, correction requests, and references to existing design entities.

The input of this step is the local feedback object on the terminal, and the output of this step is a parsed feedback structure available in server memory for further processing.

### Step 14:

The server updates the intermediate structured information using the generative AI model based on the feedback.

The server retrieves the current intermediate structured information for the design identifier from the database and generates a condensed representation of key elements.

The server constructs an augmented instruction that contains the condensed representation and the additional prompt sentence expressing the desired changes, and then tokenizes this instruction.

The server performs data processing by executing the generative AI model with this augmented input, receiving output text that describes revised segments, such as a new actor name, modified tone descriptors, or new quest descriptions.

The server parses the revised text into partial intermediate structured information, compares new values with existing values, and applies differential updates to the stored design entities.

The input of this step is the existing structured design data and the feedback-derived prompt sentence, and the output of this step is updated intermediate structured information that reflects the requested modifications.

### Step 15:

The server regenerates affected engine-ready data and triggers an updated prototype build.

The server identifies which configuration files and scripts are impacted by changes in the intermediate structured information, such as actor descriptions or quest lists.

The server performs data processing by regenerating only those files using updated template filling, thereby reducing the amount of recomputation and file I/O compared to regenerating all files.

The server passes the updated files to the digital content generation apparatus, instructs the apparatus to rebuild or reload the affected components, and receives a new prototype identifier or updated version reference.

The input of this step is the updated structured design data and previous build information, and the output of this step is a revised prototype artifact and updated prototype reference stored by the server.

### Step 16:

The server and the terminal iteratively repeat feedback and update processing until the user approves a final version.

The server sends updated prototype access information to the terminal, and the terminal presents the revised prototype to the user for evaluation.

The user continues to provide additional prompt sentences and feedback if further changes are needed, and the terminal and server perform repetition of feedback transmission, model-based update, and selective regeneration.

When the user determines that the prototype satisfies the intended design, the user issues an approval command via the terminal.

The input of this step is the sequence of prototype versions and user decisions, and the output of this step is an approval signal associated with a final prototype version.

### Step 17:

The server generates distribution information for the final version and transmits it to a content distribution platform.

The server retrieves final intermediate structured information and prototype metadata, including world setting summary, main actor description, objectives, and technical build parameters.

The server performs data processing by composing explanatory text, selecting or generating tags and categories, and aggregating all necessary identifiers into a distribution information object that conforms to an interface specification of the content distribution platform.

The server sends this distribution information, including a reference to the executable build, to the content distribution platform using a programmatic interface and receives publication confirmation data such as content IDs or URLs.

The input of this step is the final design data and prototype identifier, and the output of this step is successful publication information recorded on the server and accessible to the terminal for display to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional digital content creation workflows, the construction of virtual environments typically requires a content creator to manually translate high-level conceptual descriptions into low-level scene configuration data. For example, when a user expresses a desired scene in natural language, such as a request for a particular arrangement of entities in a game world, conventional systems generally require a human operator with specialized knowledge of a content generation engine, asset libraries, coordinate systems, and scene graph structures to interpret the user's request and to implement the corresponding object placements. This manual translation from user intent to engine-specific configuration results in several technical problems, including increased processing latency, inefficient use of computing resources, and high dependence on expert human intervention.

In many existing systems, a natural-language interface is used only as a preliminary design aid, while the actual scene data fed into a digital content generation apparatus is still assembled by scripting or direct editing. Consequently, round-trip refinement of a virtual environment—such as adjusting object density, correcting spatial relationships, or enforcing user-specified constraints—requires repetitive manual editing operations and multiple render/review cycles. This leads to redundant computations on both a server and a user terminal, including repeated loading and reloading of scene data, excessive invocation of rendering processes for intermediate previews, and non-optimized communication patterns between the analysis component and the content generation component.

Furthermore, in systems where a generative AI model is introduced, the model output is often treated as a one-shot suggestion, and there is no structured mechanism to feed back information about the actual placement result into the model for iterative correction. The lack of a closed feedback loop between the model's structured output, the digital content generation apparatus, and the subsequent scene state causes a technical mismatch between the user's high-level intent and the final rendered environment. This mismatch results in additional manual adjustments, inefficient utilization of computational resources, and suboptimal convergence of the virtual environment configuration.

There is thus a need for a system that technically improves computer-based virtual environment construction by automatically converting a user's natural-language prompt sentence into structured placement information, by mapping such information to engine-specific placement instructions, and by iteratively correcting object placement using a feedback loop that incorporates actual placement results and user feedback into further generative AI model processing. Such a system should reduce the computational overhead of repeated manual editing, streamline data processing between the server and the digital content generation apparatus, and improve the accuracy and efficiency with which the generated virtual environment reflects the user's intent.

The specific processing by the specific processing unit 290 of the data processing device 12 in Example 2 is realized by the following means.

The present invention provides a server comprising a processor configured to receive input information including a prompt sentence from a user terminal and convert the input information into model input data to be supplied to a generative AI model, to cause the generative AI model to analyze settings and contents of a virtual environment based on the prompt sentence and to output structured data describing objects to be placed and relationships among the objects, to convert the structured data into placement information by referencing resource information stored in a resource information storage unit and determining identification information of object resources and placement positions of the object resources, to convert the placement information into placement instruction data interpretable by a digital content generation apparatus and to transmit the placement instruction data to the digital content generation apparatus so as to cause the digital content generation apparatus to construct the virtual environment, to acquire placement result information indicating an actual placement result of the objects in the virtual environment from the digital content generation apparatus and feedback information relating to the virtual environment from the user terminal, to generate analysis input data including at least the prompt sentence and the placement result information and to supply the analysis input data to the generative AI model so as to cause the generative AI model to generate correction instruction data for correcting the virtual environment, and to update the placement instruction data on the basis of the correction instruction data and to re-transmit updated placement instruction data to the digital content generation apparatus so as to iteratively correct placement of the objects in the virtual environment. This enables technical improvements in computer-based virtual environment generation, including automated translation of natural-language user intent into engine-specific placement data, reduction of redundant manual editing operations and associated processing overhead, and more efficient convergence of scene configuration through a closed feedback loop that leverages actual placement results and user feedback in subsequent generative AI model processing.

The term “processor” refers to a hardware or virtual computing unit, such as a central processing unit or graphics processing unit or a plurality thereof, configured to execute instructions of a program to perform data processing, control, and communication operations in the system.

The term “user terminal” refers to an information processing apparatus operated by a user, such as a personal computer, a portable terminal, or any other computing device having an input unit, a display unit, and a communication unit, and configured to transmit a prompt sentence and feedback information to a server and to present a virtual environment to the user.

The term “prompt sentence” refers to a text sequence expressed in a natural language and provided by a user, the text sequence describing settings, contents, or desired configurations of a virtual environment and serving as input information for a generative AI model.

The term “generative AI model” refers to a trained machine learning model, such as a neural network model, configured to perform natural language processing or related inference to generate or transform data, including analyzing a prompt sentence and outputting structured data or correction instruction data for constructing or correcting a virtual environment.

The term “model input data” refers to data generated from input information including a prompt sentence and optionally additional context information, the data being formatted and structured so as to be suitable for input to a generative AI model.

The term “virtual environment” refers to a computer-generated environment, such as a game world or simulation space, composed of one or more objects arranged according to configuration data and capable of being rendered or otherwise presented on a display.

The term “structured data” refers to data output from a generative AI model in a machine-readable format, such as a list, table, or hierarchical representation, that explicitly specifies types, quantities, attributes, and relationships of objects to be placed in a virtual environment.

The term “object” refers to an element constituting at least part of a virtual environment, such as a character, building, terrain feature, or other entity, that can be represented by resource data and positioned within the virtual environment.

The term “resource information” refers to information associating object types or categories with corresponding digital resources, such as identifiers of three-dimensional models, textures, or behavior definitions, to be used when constructing a virtual environment.

The term “resource information storage unit” refers to a storage apparatus or storage area, implemented by a memory device or storage device, configured to store resource information including identification information and attributes of object resources used by a digital content generation apparatus.

The term “object resource” refers to digital data representing at least one aspect of an object in a virtual environment, such as geometry data, appearance data, or control data, which can be instantiated or referenced by a digital content generation apparatus.

The term “identification information” refers to data, such as an identifier, name, or index, that uniquely or distinguishably specifies an object resource or other data element within a system or storage unit.

The term “placement position” refers to a set of position-related values, such as coordinates in a two-dimensional or three-dimensional space and optionally orientation or scale information, indicating where and how an object resource is to be placed in a virtual environment.

The term “placement information” refers to data including identification information of one or more object resources and corresponding placement positions, the data being generated on the basis of structured data output from a generative AI model and used to construct a virtual environment.

The term “digital content generation apparatus” refers to a hardware and software configuration, such as a content generation engine or content creation software, configured to generate, edit, and render digital content including virtual environments from input data such as placement instruction data.

The term “placement instruction data” refers to data derived from placement information and formatted in accordance with an interface specification of a digital content generation apparatus, the data being interpretable by the apparatus to instantiate or arrange object resources in a virtual environment.

The term “placement result information” refers to data indicating an actual arrangement of objects produced by a digital content generation apparatus in a virtual environment, including at least object identifiers and corresponding placement positions after construction or update of the environment.

The term “feedback information” refers to information relating to a virtual environment that is provided by a user through a user terminal, the information including evaluations, modification requests, or other indications of desired changes with respect to the current state of the virtual environment.

The term “analysis input data” refers to data generated for input to a generative AI model and including at least a prompt sentence and placement result information, and optionally feedback information, for causing the generative AI model to analyze a current virtual environment and generate correction instruction data.

The term “correction instruction data” refers to data output from a generative AI model based on analysis input data, the data including instructions or parameters for changing at least one of types, attributes, or placement positions of objects in a virtual environment.

The term “content generation engine” refers to a software system configured to programmatically construct, manage, and render digital content, including three-dimensional scenes or interactive content, in response to input data such as placement instruction data.

The term “content creation software” refers to an application program providing a user interface and editing functions that enable a user or external system to create, modify, and manage digital content, including scenes of a virtual environment.

The term “natural language processing” refers to processing performed by a machine learning model or program to interpret, analyze, or generate information expressed in a natural language, including tasks such as semantic analysis, relationship extraction, and intent interpretation.

The term “semantic analysis” refers to processing by which a system determines meanings, roles, and attributes of words, phrases, or sentences contained in input data, such as a prompt sentence, in order to extract information about desired settings or contents of a virtual environment.

The term “relationship analysis” refers to processing by which a system determines relationships, such as spatial relationships or logical relationships, between objects or entities described in input data, and outputs information representing those relationships in a structured form.

The term “scene information” refers to data representing a configuration of a virtual environment at a given time, including at least a set of objects and their placement positions, and being suitable for use in rendering or displaying the virtual environment.

In one embodiment, a server provides a system that cooperatively operates with one or more terminals used by users to construct and iteratively refine a virtual environment. The server includes a processor, a main memory, a non-volatile storage device, and a network interface. The processor is, for example, a multi-core central processing unit and optionally a graphics processing unit. The main memory is, for example, a dynamic random-access memory. The non-volatile storage is, for example, a solid-state drive storing an operating system, a middleware stack, a generative AI model, a resource information storage, and server-side application programs. The network interface is, for example, an Ethernet or wireless communication interface supporting secure transport protocols such as HTTPS.

The terminal is, for example, a personal computer, a tablet device, or another information processing apparatus that includes a processor, a memory, a display unit, an input unit, and a communication unit. The terminal executes digital content generation software such as a three-dimensional content generation engine or an interactive content creation tool. In one embodiment, the terminal executes a general-purpose game engine; in another embodiment, the terminal executes custom content creation software implemented on top of a rendering library. The terminal communicates with the server through a network and presents a constructed virtual environment to the user on the display unit.

The user operates the terminal to input a prompt sentence in natural language that describes a desired configuration of a virtual environment. The user, for example, enters one of the following prompt sentences:

“I want to create an elf village in the middle of a forest. Place five houses around a central square, and surround the village with dense trees.”

“Create a medieval town with a central castle, a marketplace in front of the castle, and residential houses arranged along two main roads extending from the marketplace.”

“Generate a sci-fi space station interior with a central control room, three corridors leading to crew quarters, and large windows showing a planet outside.”

“Build a desert village with ten small houses around an oasis, a watchtower on a nearby dune, and scattered palm trees between the houses and the oasis.”

“Design a snowy mountain village with a lodge at the center, three ski cabins nearby, and pine trees covering the slopes around the village.”

The terminal converts the prompt sentence into text data encoded in a character code such as UTF-8 and encapsulates the text data in a request data structure that further includes metadata such as a user identifier and a project identifier. The terminal transmits this request data structure to the server via the communication unit.

The server receives the request data structure through the network interface and stores the prompt sentence, the metadata, and an associated timestamp in the non-volatile storage device. The server thus maintains a history of user input and constructed virtual environments, allowing efficient re-use and incremental updating without reprocessing the entire environment from scratch. This data management improves the computational efficiency of the system by enabling partial updates.

The server executes a generative AI model stored in the storage device. The generative AI model is, for example, a neural network having a transformer architecture with a plurality of attention layers, feed-forward layers, and layer-normalization units. The model is trained by supervised learning and/or self-supervised learning on a large corpus of text and scene-structure pairs. The server loads the generative AI model into memory and executes the model by using a machine learning framework running on the processor and, when available, on the GPU. The generative AI model receives tokenized versions of the prompt sentence and related context as model input data.

In one embodiment, the server performs tokenization by mapping each word, sub-word, or character in the prompt sentence to an integer index using a pre-defined vocabulary table. The server then converts each index into a continuous vector, referred to as an embedding, using an embedding matrix stored in memory. The server feeds the embeddings into a stack of transformer layers in which self-attention mechanisms compute attention weights between all token positions. The attention weights represent relevance between different parts of the prompt sentence, for example, relationships between “houses”, “central square”, and “surrounding trees.” The transformer layers compute context-aware representations by weighted summation of token embeddings followed by non-linear transformations in feed-forward sublayers.

The server configures the generative AI model to output a structured representation of the desired virtual environment, rather than free-form text. For example, the server defines a constrained output format in which the model generates tags and delimiters that denote object types, counts, spatial relationships, and attributes. During decoding, the model applies a beam search or constrained decoding algorithm that limits generated tokens to a grammar representing valid fields such as “OBJECT_TYPE”, “COUNT”, “RELATION”, and “ATTRIBUTE.” By constraining the output in this way, the server reduces parsing errors and improves the precision of object and relationship extraction, thereby achieving a technical improvement in the reliability of downstream placement processing.

The server converts the model output into structured data, for example, a tree or table structure representing a list of object specifications. Each object specification includes at least an object category (for example, “house”, “tree”, “square”, “castle”, “road”), a desired count, and one or more spatial relations (for example, “around center”, “surrounding ring”, “along axis”, “adjacent to”). The server further includes confidence values produced by the generative AI model for each field, and discards or replaces values whose confidence falls below a threshold, thereby reducing the influence of uncertain predictions. In one embodiment, the server applies post-processing rules that correct inconsistent combinations, such as negative counts or spatial constraints that contradict each other.

The server then maps the abstract object specifications in the structured data to concrete object resources maintained in a resource information storage unit. The resource information storage unit is, for example, implemented as a relational database or a key-value store in the server's non-volatile storage, associating each object category with one or more asset identifiers, bounding box dimensions, default orientations, and physical properties. The server queries this storage unit using the object category and attributes from the structured data and selects appropriate object resources. When multiple resources are available, the server applies selection criteria based on style, scale, or performance constraints. For example, for an “elf house” category, the server selects one of several house assets depending on a performance setting for low or high graphical detail.

The server computes placement positions for each object resource. In one embodiment, the server represents space in the virtual environment using a three-dimensional coordinate system. The server converts high-level spatial relations derived from the structured data into numeric coordinates by applying dedicated placement algorithms. For example, for an instruction “five houses around a central square,” the server chooses a radius value and evenly distributes five placement positions along a circle centered at the square. The server computes each house position by converting from polar coordinates to Cartesian coordinates and checks for collisions between objects using bounding box data obtained from the resource information storage unit.

For a relation “surround the village with dense trees,” the server defines an annular region around a center point or around a convex hull of already placed houses and other objects. The server then performs random sampling of candidate positions within this region and uses a minimum distance constraint between tree positions to create a visually dense but non-overlapping configuration. By performing these geometric computations automatically, the server reduces the amount of repeated manual layout editing and ensures consistent spacing and coverage according to rules that can be tuned algorithmically. The server thereby improves computational efficiency of layout generation as compared to manual editing plus ad hoc scripting.

After all placement positions are determined, the server generates placement information including identification information of object resources and the computed placement positions. The server then converts the placement information into placement instruction data interpretable by the digital content generation software running on the terminal. In one embodiment, the server generates a data structure that the engine's editor interface can read to instantiate meshes or prefabricated object templates at specified locations. The server manages this placement instruction data in a versioned manner so that later corrections can be applied incrementally rather than reconstructing the entire scene, thereby reducing network traffic and processing workload on both server and terminal.

The terminal receives the placement instruction data and passes it to the digital content generation software. The terminal's processor invokes the engine's application programming interface to load the referenced object resources, allocate memory for object instances, and register the instances in a scene graph. The terminal then performs rendering operations by traversing the scene graph, computing transformation matrices, performing visibility determination, and invoking a graphics pipeline to generate an image for display on the display unit. Because the placement instruction data has already been processed to avoid collisions and to satisfy layout rules, the engine can render a plausible virtual environment without requiring multiple costly reconstruction cycles.

The user inspects the rendered virtual environment on the terminal and optionally provides feedback. For example, the user may issue additional prompt sentences such as:

“Spread the houses a bit more and make the central square larger.”

“Add a small river along the east side of the village and connect it with a wooden bridge from the square.”

“Increase the density of trees to the north side of the village.”

The terminal transmits this feedback information to the server together with an identification of the current scene state. Additionally, the terminal or the digital content generation software sends placement result information back to the server. This placement result information includes, for example, a list of objects, each with its object resource identifier, final placement position, and bounding volume. In some embodiments, the terminal also transmits camera viewpoints or visibility metrics to allow analysis of whether important objects are properly visible.

The server forms analysis input data that includes at least the original prompt sentence, the placement result information, and, when present, the user feedback. The server again tokenizes the textual portions and encodes the numeric placement data into a compact representation suitable for input to the generative AI model. For example, the server encodes each object's type and coordinates as tokens or as numeric feature vectors and concatenates them with text tokens. The server may also include specialized separator tokens that distinguish between user intent text and current scene description. This unified representation allows the generative AI model to compare the intended configuration with the actual configuration and to identify discrepancies.

The generative AI model, running on the server, performs a second-stage analysis using the analysis input data. The transformer architecture processes both the natural language description and the structured scene summary so that attention mechanisms can learn associations between phrases like “around the central square” and specific groups of objects and coordinates. During training, the model is optimized with a loss function that penalizes discrepancies between predicted corrections and target corrections obtained from annotated scene refinements. For example, the training process may use a combination of cross-entropy loss for token predictions and a regression loss for numeric adjustment parameters such as distance increases or density multipliers. The server updates the weights of the model during training using an optimization algorithm such as stochastic gradient descent with momentum or adaptive moment estimation. During inference, the server uses the trained weights and does not perform weight updates.

The server uses the model's output to generate correction instruction data. The correction instruction data specifies operations such as “increase radius of house ring by a certain value,” “add a specified number of trees in a particular angular sector,” or “move an object to a position that increases visibility from a primary viewpoint.” The server converts these high-level correction instructions into concrete coordinate updates by recomputing positions using the same geometric algorithms as in the initial placement but with modified parameters. Because the generative AI model operates on a compact, structured representation of both intent and current placement state, the model can propose coordinated changes that optimize multiple spatial constraints simultaneously. This differs from human manual tuning, which often adjusts one object at a time and leads to suboptimal global configurations.

The server then updates the placement instruction data based on the correction instruction data. The server calculates differences between the new and previous placements and transmits only delta information to the terminal where possible, such as movement commands for selected objects and addition or removal of specific objects. By limiting communication to incremental changes, the server reduces network bandwidth and decreases the time required for the terminal to apply the updates, leading to faster feedback cycles and reduced computational load. This effect is particularly significant when the virtual environment becomes large and complex.

The terminal receives the updated placement instruction data and commands the digital content generation software to move objects, add new objects, or delete objects in accordance with the updated data. The engine updates the scene graph, recalculates only affected parts of the scene, and re-renders the view. Because the updates are localized, the terminal can reuse cached rendering data for unaffected regions and thus further reduces rendering time. As a result, the user experiences a smoother, more responsive editing process compared to conventional full-scene regeneration.

This system improves computer technology in several ways. First, by constraining the generative AI model to produce structured, machine-readable outputs and by tightly coupling those outputs with engine-specific placement algorithms, the server reduces the need for error-prone parsing and manual data conversion. This leads to improved accuracy in the mapping from natural language intent to virtual environment configuration. Second, by maintaining an explicit feedback loop that uses actual placement result information and user feedback as inputs for further generative processing, the server enables a closed-loop optimization of scene layout that converges more quickly and with fewer manual interventions than traditional design workflows. Third, by using specialized spatial algorithms and incremental update mechanisms, the system reduces redundant computation and network transmissions, thereby increasing processing speed and reducing communication load.

Furthermore, the generative AI model in this system does not merely automate human textual interpretation. The model operates on an internal representation that fuses linguistic features and geometric features, and it is trained to predict layout parameters and correction operations that are not explicitly specified by the user. The model, for example, learns non-trivial layout patterns such as evenly distributing objects along irregular boundaries, adjusting densities based on occlusion probabilities, and organizing paths and open spaces for improved navigability. These operations represent non-conventional, computer-specific heuristics and optimization strategies that are difficult for a human to implement consistently at scale.

In another embodiment, the server employs additional rule-based modules that run alongside the generative AI model. These modules compute quantitative metrics, such as average nearest-neighbor distances between objects, coverage ratios of foliage in specified regions, and visibility scores for key landmarks from main camera positions. The server inputs these metrics to the generative AI model as numeric tokens or additional features, guiding the model to propose corrections that explicitly improve such metrics. Because the system directly optimizes engine-relevant quantitative measures, it achieves technical improvements in rendering efficiency and visual clarity.

In yet another embodiment, the server adapts the complexity of placement computations based on resource constraints communicated from the terminal. For example, when the terminal indicates limited processing capacity or display resolution, the server selects lower-detail object resources and simpler layouts that minimize overdraw and polygon count.

Conversely, when higher performance is available, the server selects higher-detail resources and richer layouts. This resource-aware adaptation is implemented algorithmically in the server and results in controlled computational load on the terminal and improved overall system performance.

The described embodiments can be varied without departing from the scope of the claimed invention. For example, the generative AI model may be implemented as a different neural network architecture such as a recurrent neural network augmented with attention mechanisms, or as a hybrid model combining rule-based pre-processing with transformer-based generation. The digital content generation software on the terminal may be any engine or tool that can interpret placement instruction data and render a virtual environment. The hardware configuration of the server and terminal may also vary, including on-premise servers, cloud-based servers, and mobile terminals. In each case, the server, the terminal, and the user interact as described to achieve automatic, iterative construction and correction of a virtual environment based on prompt sentences and feedback, with technical improvements in processing efficiency, accuracy, and resource utilization.

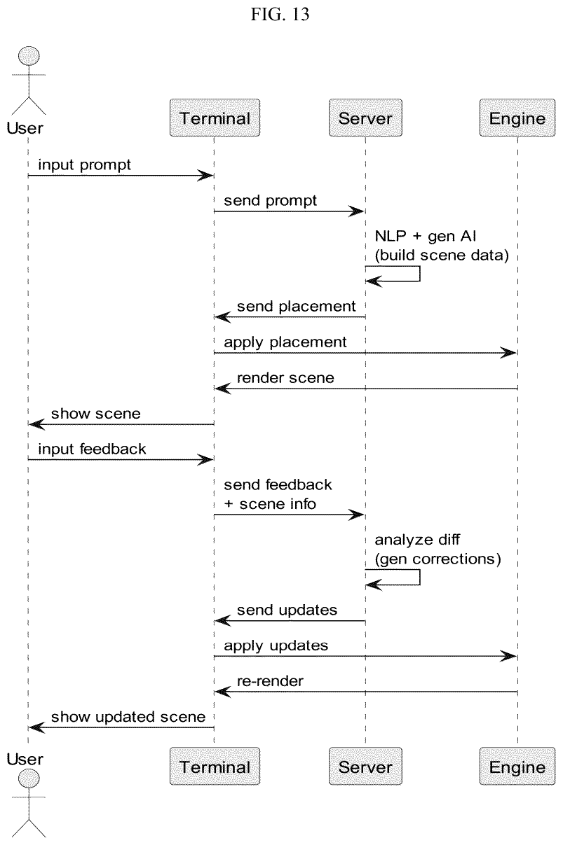

The following describes the processing flow using FIG. 13.

### Step 1:

The user operates the terminal to launch a content-creation application and inputs a prompt sentence in natural language through a keyboard, pointing device, or voice-to-text interface. The input of this step is a human-readable text description such as “I want to create an elf village in the middle of a forest. Place five houses around a central square, and surround the village with dense trees.” The terminal converts this human input into digital text data encoded in a character encoding scheme, attaches metadata such as a user identifier and a project identifier, and outputs a structured request object containing the prompt sentence and the metadata.

### Step 2:

The terminal transmits the structured request object to the server via a communication unit using a network protocol such as HTTPS over TCP/IP. The input of this step is the structured request object produced in Step 1. The terminal encapsulates the object into a network message, performs encryption and authentication according to a security protocol, and outputs a network packet stream addressed to the server.

### Step 3:

The server receives the network packet stream through a network interface and reconstructs the structured request object by performing protocol stack processing such as TCP reassembly and HTTP parsing. The input of this step is the encrypted packet stream from the terminal. The server decrypts the payload, verifies integrity and any authentication token, and parses the body into an internal data structure containing the prompt sentence and metadata. The server outputs a validated request record and stores it in a storage device for later reference and logging.

### Step 4:

The server generates model input data for a generative AI model by preprocessing the prompt sentence and optional context information. The input of this step is the validated request record including the prompt sentence, user identifier, and project state. The server applies natural language preprocessing, such as normalization, tokenization into sub-word units, and mapping from tokens to integer identifiers using a vocabulary table. The server also constructs additional fields such as special tokens indicating start and end of the prompt, and optionally appends context tokens representing current scene state. The server outputs a sequence or tensor of token identifiers and associated attention masks that conform to the input format of the generative AI model.

### Step 5:

The server executes the generative AI model on the model input data to obtain structured data describing objects and relationships in the virtual environment. The input of this step is the tensor representation of the tokenized prompt and context. The server loads a transformer-based neural network model into memory, performs embedding lookup to convert token identifiers to continuous vectors, and propagates the vectors through multiple layers of self-attention and feed-forward computations. During decoding, the server applies a constrained decoding algorithm or beam search to generate tokens representing object types, counts, spatial relations, and attributes in a pre-defined schema. The server converts the generated tokens back into higher-level symbols and outputs structured data such as a list of object specifications with fields including category, quantity, relation, and attribute.

### Step 6:

The server validates and normalizes the structured data to prepare it for asset mapping and geometric computation. The input of this step is the raw structured data emitted by the generative AI model. The server checks each object specification for required fields (for example, that a count is non-negative and a category is recognized), applies default values when fields are missing, and removes or corrects logically inconsistent entries based on rule-based constraints (for example, disallowing a negative radius or conflicting spatial directives). The server may compute confidence scores from the generative AI model outputs and discard entries below a threshold. The server outputs a sanitized and complete structured object list ready for mapping to object resources.

### Step 7:

The server maps each abstract object specification to a concrete object resource by querying a resource information storage unit. The input of this step is the sanitized structured object list. The server extracts fields such as category and style attribute from each specification and issues queries to a resource database that associates categories with asset identifiers, bounding box sizes, and rendering properties. The server applies selection logic, such as choosing a low-detail asset for performance-constrained terminals or selecting a particular style variant based on theme attributes. The server outputs placement-ready entries that pair each object specification with a specific object resource identifier and associated physical parameters such as dimensions and default orientation.

### Step 8:

The server computes placement positions and orientations for each object resource using geometric algorithms derived from the spatial relations in the structured data. The input of this step is the placement-ready entries including object categories, resource identifiers, and target relationships such as “around center” or “surrounding ring.” The server converts high-level relations into numerical parameters, for example, setting a radius and angular separation for objects arranged in a circle, or defining an annular region for dense tree placement. The server then performs calculations such as polar-to-Cartesian conversion, random sampling under minimum distance constraints, collision checks using bounding boxes, and alignment with landmark objects. The server outputs placement information that specifies, for each object resource, a three-dimensional position, an orientation, and optionally a scale factor.

### Step 9:

The server converts the placement information into placement instruction data formatted for direct interpretation by the digital content generation software on the terminal. The input of this step is the placement information produced by the geometric computation. The server serializes the information into a predefined data schema, such as a scene description schema compatible with an engine's scripting interface or editor API, and includes object resource identifiers, positions, rotations, and any configuration parameters needed by the engine. The server may also add version identifiers and checksums for synchronization control. The server outputs a placement instruction dataset suitable for transmission.

### Step 10:

The server transmits the placement instruction data to the terminal over the network. The input of this step is the serialized placement instruction dataset. The server encapsulates the dataset in a network message, applies compression and encryption if configured, and sends the message to the terminal using a communication protocol such as HTTPS or a persistent WebSocket. The server outputs a sequence of network packets carrying the placement instructions.

### Step 11:

The terminal receives the placement instruction data and forwards it to the digital content generation software. The input of this step is the packet sequence containing placement instructions. The terminal decapsulates and decrypts the packets, reconstructs the serialized dataset, and parses it into an internal representation. The terminal then calls the engine's interface or scripting mechanism and passes object resource identifiers and placement parameters to the engine. The terminal outputs engine-level commands or API calls that cause the engine to instantiate or manipulate scene objects.

### Step 12:

The terminal causes the digital content generation software to construct and render the virtual environment based on the placement instructions. The input of this step is the engine-level commands describing objects to be instantiated and their positions. The engine loads the specified object resources from local or cached storage, allocates graphics resources such as meshes and textures, and inserts each object into a scene graph with the corresponding transform. The terminal's processor and graphics hardware perform culling, lighting calculation, and rasterization to generate rendered images or frames depicting the constructed virtual environment. The terminal outputs a visual representation of the scene on the display unit and optionally an updated internal scene state.

### Step 13:

The terminal collects placement result information and transmits it, along with any user feedback, back to the server. The input of this step is the current scene state maintained by the engine and the user's reactions or new prompt sentences. The terminal extracts from the scene graph a list of objects with their final positions, orientations, and identifiers and organizes this data as placement result information. The user may input an additional prompt sentence such as “Spread the houses a bit more and make the central square larger.” The terminal packages the placement result information and the feedback text into a structured message and outputs this message as a request to the server.

### Step 14:

The server receives the placement result information and user feedback and prepares analysis input data for further processing by the generative AI model. The input of this step is the structured message from the terminal containing the current scene description and feedback. The server merges the original prompt sentence, the placement result information, and the feedback into a unified representation. The server tokenizes the textual elements and encodes object categories and coordinates into numeric feature vectors, optionally discretizing coordinates into tokens or embedding them as numerical features. The server constructs an ordered sequence that distinguishes between user-intent segments and scene-description segments using dedicated separator tokens. The server outputs an analysis input tensor suitable for the generative AI model.

### Step 15:

The server executes the generative AI model to derive correction instruction data from the analysis input data. The input of this step is the analysis input tensor. The server feeds this tensor into the transformer-based neural network, where attention layers compute dependencies between intent expressions and current object placements. The model processes the combined sequence and generates tokens or vectors representing correction operations, such as adjustments to radii, additional object counts in specific regions, or movement directions for existing objects. The server decodes these outputs into a structured set of correction instructions and applies post-processing rules to ensure numeric validity and consistency. The server outputs correction instruction data that specifies how to modify the virtual environment.

### Step 16:

The server updates the placement instruction data on the basis of the correction instruction data and produces incremental update information. The input of this step is the previous placement instruction dataset and the newly produced correction instructions. The server applies the corrections by recomputing affected placement positions, adjusting parameters such as spacing or density, and possibly adding or removing object entries. The server then computes differences between the updated dataset and the previous dataset, for example, by identifying objects whose transforms have changed or whose existence has been added or removed. The server outputs delta placement instruction data that encodes only the changes needed to bring the existing scene into conformity with the corrected configuration.

### Step 17:

The server transmits the delta placement instruction data to the terminal for incremental scene updates. The input of this step is the delta instruction dataset. The server packages the delta into a compact message, applies compression and encryption if configured, and sends it to the terminal through the network interface. By transmitting only differences instead of the full scene description, the server reduces network load and shortens update time. The server outputs network packets carrying incremental update commands.

### Step 18:

The terminal receives the delta placement instruction data and applies it to the existing scene in the digital content generation software. The input of this step is the network packets containing incremental update commands. The terminal reconstructs the delta dataset, parses the changes, and, through the engine API, issues commands to move specified objects, create additional instances, or delete objects that are no longer needed. The engine updates the scene graph for the affected nodes, recomputes transforms and visibility only for modified regions, and re-renders the view. The terminal outputs an updated visual representation of the virtual environment that reflects the corrections derived from the generative AI model and the user feedback.

### Step 19:

The user observes the updated virtual environment on the terminal and decides whether additional refinement is required or whether the current scene is satisfactory. The input of this step is the rendered view of the corrected scene. The user may either provide further prompt sentences with additional constraints or, if the scene is acceptable, issue a finalize command through the user interface. When the scene is finalized, the terminal and the server coordinate to export the final scene data into a persistent storage format defined by the digital content generation software. The terminal outputs finalized scene data files and, when applicable, success status messages to the server, completing the iterative refinement cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional digital content authoring systems for virtual environments and interactive content require human experts to manually translate user intentions into engine-specific configuration data. In such systems, a user typically provides free-form text descriptions or high-level concepts, and a designer or engineer must then interpret the descriptions, design the scene, encode object placement and behavioral parameters, and iteratively adjust the content. This workflow is labor-intensive, slow, and error-prone. Furthermore, conventional pipelines generally lack an automated mechanism for integrating user feedback and user emotional state into the content generation loop. As a result, the generated virtual environments and interactive content are not efficiently tailored to a user's evolving intent or emotional response, and computing resources in the content generation engine are not optimally driven by structured, machine-generated specifications.

In addition, many existing uses of generative AI models simply return natural language text or unstructured design notes that still require extensive manual post-processing before being usable by a digital content generation apparatus, such as a three-dimensional content engine or an interactive content development platform. There is no integrated control logic on the server side that (i) systematically converts natural-language user requirements into machine-readable prompt sentences, (ii) transforms AI outputs into engine-ready configuration data, (iii) loops user feedback back into new prompt sentences to drive automated revision, and (iv) uses emotion recognition results to dynamically adjust prompts and content parameters. This lack of end-to-end automation leads to inefficient utilization of generative AI models and content engines, increased latency in iterations, inconsistent quality of generated scenes, and limited personalization.

Moreover, existing systems that consider user emotion often do so only at the presentation layer, for example by changing colors or soundtracks in an ad hoc manner on the client side, without integrating emotion data into the core content generation logic. There is no mechanism by which a server coordinates an emotion recognition process with a generative AI model and a digital content generation apparatus to systematically control how scene configurations, narrative elements, object density, or visual effects are computed.

Consequently, the underlying computer-implemented pipeline is not improved to automatically adapt its data generation and transformation steps based on user emotion, and the system cannot efficiently maintain or enhance user engagement through emotionally adaptive content.

Accordingly, there is a need for a computer-implemented system and server-side control method that improve the way generative AI models and digital content generation apparatuses are orchestrated. Such a system should automatically and repeatedly: (i) construct and refine prompt sentences from user requirements and feedback, (ii) convert generative outputs into engine-specific configuration information, and (iii) incorporate emotion recognition results into both prompt construction and content configuration. By doing so, the system can improve the technical operation of the content generation pipeline itself, reduce manual intervention, shorten iteration cycles, and generate virtual environments and electronic content that are more consistent with user intent and emotional state.

The specific processing by the specific processing unit 290 of the data processing device 12 in Application Example 2 is realized by the following means.

The present invention provides a server comprising a processor configured to acquire request information in natural language from a user, generate a prompt sentence based on the request information, input the prompt sentence into a generative AI model, obtain configuration information of a virtual environment or electronic content from the generative AI model, convert the configuration information into setting information that is directly consumable by a digital content generation apparatus, and transmit the setting information to the digital content generation apparatus, the processor being further configured to acquire output information generated by the digital content generation apparatus, present the output information to the user, acquire additional input information including a modification request from the user, generate a correction prompt sentence based on the additional input information and evaluation information derived from the output information, re-input the correction prompt sentence into the generative AI model to update the configuration information, execute emotion recognition processing to estimate an emotional state of the user from facial information or voice information, dynamically adjust at least one of the prompt sentence, the correction prompt sentence, and the setting information in accordance with the emotional state, and instruct the digital content generation apparatus to regenerate or adjust the virtual environment or the electronic content based on the updated configuration information and the emotional state. This enables the server to implement an integrated, iterative control loop that automatically transforms unstructured user input and emotion signals into machine-optimized configuration data for a content engine, thereby improving the technical operation of the generative pipeline, reducing manual post-processing, accelerating content updates, and generating virtual environments and electronic content that are more precisely aligned with user intent and emotional response.

The term “processor” refers to a hardware or virtual computation unit, such as a central processing unit, graphics processing unit, or virtual machine instance, that executes machine-readable instructions to perform data acquisition, analysis, transformation, and control operations.

The term “information processing apparatus” refers to an electronic apparatus, such as a server, client device, or computing node, that is capable of receiving, storing, and processing digital data and communicating with other devices over a communication network.

The term “user” refers to a human operator or entity that provides request information, feedback, or other inputs to the system and receives output information such as generated virtual environments or electronic content.

The term “request information” refers to information including one or more natural language expressions that indicate a desired virtual environment, electronic content, or modification thereof, provided by the user to the system.

The term “natural language” refers to human language, such as sentences or phrases, that is not constrained to a formal programming syntax and that can be processed by a natural language processing function of the system.

The term “prompt sentence” refers to a machine-generated or transformed text string that is input to a generative AI model and that encodes at least part of the user's request information, context information, or control instructions for the generative AI model.

The term “correction prompt sentence” refers to a prompt sentence generated based on additional input information, evaluation information, or both, and re-input to the generative AI model to cause the generative AI model to update previously generated configuration information.

The term “generative AI model” refers to a machine learning model, such as a generative language model, that receives a prompt sentence as input and outputs new data including configuration information, modification information, or adjustment information.

The term “machine learning model” refers to a computational model trained using example data to learn parameters or patterns so as to perform tasks such as classification, generation, or transformation of input data without being explicitly programmed for each task.

The term “natural language processing function” refers to a capability of a model or system to analyze, interpret, or generate natural language text, including tokenizing, parsing, semantic analysis, or text generation.

The term “configuration information” refers to data that describes structural and behavioral aspects of a virtual environment or electronic content, including object types, positions, relationships, visual properties, and interaction parameters.

The term “setting information” refers to configuration information converted into a specific format or data structure that can be directly interpreted and used by a digital content generation apparatus to generate or adjust a virtual environment or electronic content.

The term “digital content generation apparatus” refers to a hardware or software system, such as a rendering engine, content creation engine, or development environment, that generates, modifies, or renders virtual environments or electronic content based on setting information.

The term “virtual environment” refers to a computer-generated space, such as a two-dimensional or three-dimensional scene, that can be presented to a user via a display or immersive device and that includes one or more digital objects or interactive elements.

The term “electronic content” refers to computer-generated or computer-controlled media, such as images, animations, games, scenes, or interactive experiences, that are created or modified by the system.

The term “virtual space generation processing” refers to processing that constructs a virtual environment by creating, arranging, or modifying digital objects, camera settings, lighting, and other scene components based on configuration or setting information.

The term “output information” refers to information generated by the digital content generation apparatus, including data representing a virtual environment or electronic content, preview images, scene files, or metadata describing the generated content.

The term “additional input information” refers to information provided by the user after viewing the output information, including modification requests, preferences, or other feedback to be applied to the virtual environment or electronic content.

The term “modification request” refers to a part of the additional input information that explicitly or implicitly specifies a desired change to the virtual environment or electronic content, such as changing layout, density, style, or behavior.

The term “evaluation information” refers to information derived from the output information, the configuration information, or both, representing analysis, scoring, or rule-based assessment of the generated virtual environment or electronic content.

The term “emotion recognition processing” refers to processing that analyzes facial information, voice information, or other biometric data to estimate an emotional state of the user, such as joy, sadness, surprise, calmness, or frustration.

The term “emotional state” refers to an estimated affective condition of the user, represented by one or more labels, scores, or categories, and derived by the emotion recognition processing from user-related data.

The term “facial information” refers to digital data representing an image or sequence of images including the user's face, or features extracted from such images, used for estimating an emotional state.

The term “voice information” refers to audio data representing spoken sounds by the user, or features extracted from such audio data, used for estimating an emotional state.

The term “dynamic adjustment” refers to automatic modification of at least one of the prompt sentence, the correction prompt sentence, or the setting information in response to changing conditions such as the user's emotional state, request information, or feedback.

The term “object list” refers to a collection of entries in the configuration information that identify digital objects to be included in a virtual environment or electronic content, such as characters, furniture, environmental elements, or user interface components.

The term “placement information” refers to data specifying spatial or logical placement of objects, including positions, orientations, scales, or hierarchical relationships in a virtual environment or electronic content.

The term “visual effects” refers to properties or processes influencing the visual appearance of the virtual environment or electronic content, including materials, lighting conditions, particle systems, post-processing effects, and animations.

The term “general-purpose content generation engine” refers to a content generation system that is not limited to a single application and that is capable of constructing or rendering two-dimensional or three-dimensional digital spaces based on general configuration information.

The term “interactive content creation development platform” refers to a software platform or framework for designing, assembling, and executing interactive content, such as games or simulations, using configuration data, scripts, and assets.

The term “modification information” refers to data output by the generative AI model that indicates changes to be applied to existing configuration information, such as additions, deletions, or parameter adjustments.

The term “adjustment information for emotion adaptation” refers to data specifying how configuration information, setting information, or content parameters should be changed in order to adapt the virtual environment or electronic content to a user's emotional state.

The term “regenerate or adjust” refers to operations performed by the digital content generation apparatus to newly generate content from configuration information or to modify existing content by changing at least one parameter, object, or effect without necessarily regenerating the entire scene.

In one embodiment, the system includes a server, one or more terminals, a digital content generation apparatus, a storage apparatus, and an emotion recognition apparatus interconnected via a communication network. The server executes software modules that implement natural language processing, prompt sentence generation, generative AI model interfacing, configuration transformation, and orchestration of a content generation engine. The terminal executes a client application providing user interfaces for input and output. The digital content generation apparatus executes a content engine, such as a three-dimensional content generation engine or an interactive content creation platform. The emotion recognition apparatus executes models for estimating a user's emotional state from facial and voice data.

The server uses general-purpose computing hardware, such as a multi-core central processing unit and, optionally, a graphics processing unit, running an operating system such as a UNIX-like system. The server stores program modules and data in non-transitory storage such as solid-state drives and random access memory. The terminal uses consumer hardware such as a smartphone, tablet, or personal computer equipped with a display, microphone, and camera. The digital content generation apparatus uses a workstation or server capable of running a three-dimensional engine such as a general 3D game engine or a real-time rendering engine. The emotion recognition apparatus uses image sensors and microphones associated with the terminal or a separate device.

The server stores in the storage apparatus a set of program modules including a user request acquisition module, a prompt sentence generation module, a generative AI interface module, a configuration transformation module, a content engine control module, a feedback handling module, and an emotion adaptation module. The server also stores data structures including user profiles, project contexts, prompt logs, configuration versions, and emotion logs.

The server uses a generative AI model implemented as a transformer-based neural network trained for natural language processing. In one embodiment, the generative AI model is constructed with multiple layers of self-attention blocks, each including multi-head attention sub-layers and feed-forward sub-layers, with residual connections and layer normalization. The generative AI model uses token embeddings mapping input characters or words to high-dimensional vectors and positional encodings representing token order. The generative AI model is trained on a corpus of text including descriptions of virtual environments, game design documents, and configuration schemas. During training, the generative AI model minimizes a cross-entropy loss between predicted tokens and ground truth tokens using gradient-based optimization such as stochastic gradient descent with adaptive learning rate. The server stores the trained model parameters, including weight matrices and bias vectors for attention and feed-forward layers, in the storage apparatus.

The terminal provides an interface that allows the user to input request information in natural language. The terminal displays text entry fields, selection controls, and preview areas using a graphical user interface. The user inputs descriptions such as:

“I want to create a modern café-style virtual store.”

“I want to create a fantasy role-playing game in a medieval world.”

“I want to create an action game where the player defeats a dragon in a fantasy world.”

“The user is sad; please generate a touching and heartwarming story.”

“When the user feels surprise, please modify the virtual store display to be more dynamic.”

“When the user is deeply moved, please make the scene music more emotional and adjust the character dialogue to match the feeling.”

The terminal converts the input into a text string encoded in a character encoding format and attaches metadata such as user identifiers and context identifiers before transmitting the data to the server over the network.

The server stores the received request information in a request data structure containing fields for raw text, language, user identifier, project identifier, and timestamp. The server uses the prompt sentence generation module to construct a prompt sentence that is suitable for the generative AI model. The server combines the user's raw text with system-level instructions and output formatting constraints. For example, the server generates prompt sentences such as:

“Design a 3D virtual store with the theme: modern café. Include a detailed object list, layout description, and visual style guidelines.”

“Design a medieval fantasy role-playing game based on the following request: I want to create a fantasy role-playing game in a medieval world. Output a structured description of characters, world settings, quests, and mechanics.”

“Create an action game design where the player defeats a dragon in a fantasy world. Specify enemy behavior, player abilities, and level structure.”

“Generate a sad and heartwarming story suitable for a user who wants a sad narrative experience, while maintaining a coherent plot arc.”

“When the user feels surprise while viewing a virtual store, propose modifications to make the store display more dynamic and visually stimulating.”

“When the user feels deep emotion, adjust the scene music to be more emotional and update character dialogue to match the user's emotional state.”

The server represents the prompt sentence and associated context as a structured prompt record. The prompt record includes fields such as instruction text, user text, context references to previous prompts, and flags indicating whether the prompt is for initial generation or for correction.

The server uses the generative AI interface module to tokenize the prompt sentence. The server maps each character or word to a token identifier using a tokenization scheme, then constructs an input tensor consisting of token indices. The server passes the input tensor to the generative AI model executing on the server or on an attached accelerator device. The generative AI model computes hidden representations using self-attention and feed-forward operations, then outputs a sequence of tokens representing a response. The server decodes the output tokens into text, which typically includes a structured specification, such as a list of objects with attributes, layout descriptions, or narrative elements.

The server uses the configuration transformation module to convert the text generated by the generative AI model into configuration information. The server applies parsing algorithms, such as grammar-based parsers or pattern-based extractors, to segment the generated text into configuration entities. The server converts these entities into a configuration data structure that includes an object list and placement information. Each object entry includes attributes such as identifier, category, mesh type, material reference, and behavioral parameters. The placement information includes spatial coordinates, orientations, and scale for each object. The server may also include environment-level parameters such as lighting mode, ambient color, music track identifiers, and camera positions.

The server transforms the configuration information into setting information that can be interpreted by the digital content generation apparatus. For a three-dimensional content generation engine, the server maps object identifiers to engine-specific asset identifiers, such as prefab names or mesh file paths. The server converts coordinate systems if necessary, normalizes units, and prepares an engine configuration file or memory structure. For example, the server generates scene configuration data specifying that a table object is instantiated using a particular table asset, placed at a specified position, rotated by a given angle, and assigned a specified material. The server groups configuration elements into layers or categories to match the content engine's scene graph structure.

The server transmits the setting information to the digital content generation apparatus through an application programming interface. The digital content generation apparatus receives the setting information and uses its internal engine to construct or modify the virtual environment or electronic content. The digital content generation apparatus instantiates objects, applies materials, sets lights and cameras, and configures interactive elements based on the setting information. The digital content generation apparatus may generate one or more assets, such as a scene file, a preview image, or a build artifact for an executable application.

The server acquires output information from the digital content generation apparatus. The server receives identifiers of generated files, performance metrics, and any diagnostic information. The server stores a mapping between the configuration information version and the output information in the storage apparatus. The server forwards relevant output information, such as preview images or URLs for playing scenes, to the terminal. The terminal displays the preview images and provides controls for starting interactive sessions with the generated content.

The user reviews the output information through the terminal. The user may determine that the content does not meet desired expectations and provide additional input information describing modifications. For example, the user may input:

“Please increase the number of chairs around the counter.”

“Please make the forest denser around the elf village.”

“Please increase the dragon's movement speed by about fifty percent.”

“Please change the story to feel more cheerful while keeping the main characters.”

The terminal transmits the additional input information to the server. The server stores the additional input information together with references to the output information and the configuration version. The server also may derive evaluation information by analyzing the output information. For instance, the server may automatically compute the density of objects in a region or detect absent required elements using heuristic rules.

The server uses the feedback handling module to generate a correction prompt sentence. The server composes the correction prompt sentence by including a description of the current configuration, a summary of the output, the additional input information, and possibly evaluation information. For example, the server creates correction prompt sentences such as: “Current café layout has 8 chairs around the counter. The user requests more chairs. Adjust the design so that there are at least 20 chairs around the counter while keeping aisles walkable.”

“Current forest around the elf village has sparse trees. The user requests a denser forest. Modify the configuration to increase tree density around the village, especially near the main path.”

“Current dragon movement speed is low. The user requests a faster dragon. Adjust the game design to increase the dragon's movement speed and attack frequency without breaking difficulty balance.”

The server re-inputs the correction prompt sentence into the generative AI model. The generative AI model computes updated configuration information using its learned parameters. The server processes the updated configuration information in the same manner as the initial configuration, transforming it into revised setting information and sending it to the digital content generation apparatus. As a result, the digital content generation apparatus updates the virtual environment or electronic content according to the user's feedback.

The terminal also captures facial information and voice information of the user. The terminal uses the camera to obtain frames of the user's face and uses the microphone to record the user's voice. The terminal either transmits raw data or processed features such as facial landmarks or audio spectrograms to the server. The server uses the emotion recognition apparatus or an emotion recognition module to estimate an emotional state. In one embodiment, the server uses a convolutional neural network for facial expression recognition and a recurrent or transformer-based network for voice emotion recognition. The convolutional network processes image patches containing facial regions, extracting features from multiple convolutional layers and pooling layers, then classifies the emotion using a fully connected layer. The voice recognition network processes sequences of acoustic features such as mel-frequency cepstral coefficients and outputs an emotion label or probability distribution. The server combines visual and audio emotion estimates using a fusion algorithm, such as weighted averaging or a small fusion network.

The server stores the emotional state in an emotion log associated with the user and the current project context. The server uses the emotion adaptation module to dynamically adjust the prompt sentence, correction prompt sentence, and setting information according to the emotional state. For example, when the user's emotion is identified as sadness, the server modifies a prompt sentence for narrative generation to emphasize comforting or heartwarming elements. When the user's emotion is identified as joy, the server modifies the configuration information to add more bright colors, decorative objects, and lively animations. When the user's emotion is identified as surprise, the server adjusts prompts to request more dynamic changes, such as animated displays or unexpected environmental events.

The server, by integrating emotion recognition results into prompt and configuration generation, controls internal data structures and processing in a way that is not a simple automation of human design work. The server selects particular ranges of parameters and design alternatives based on affective signals, resulting in distinct configurations that a human designer may not systematically generate in real time. The system's usage of emotion signals is not merely display-level decoration but feeds back into the generative AI model and configuration transformation, changing object densities, layout complexity, timing of events, and narrative branching. This tightly coupled loop improves the technical functioning of the system by enabling it to converge more quickly to configurations that match the user's state, reducing the number of required iterations and saving computational and communication resources.

The server imposes specific internal data structures and processing sequences that improve computer operation. For example, the server stores prompt records and configuration versions in compressed representations and computes differences between versions using structural diff algorithms. By reusing unchanged sub-configurations, the server sends only incremental updates to the digital content generation apparatus, reducing network bandwidth and processing time. The server also caches generative AI outputs associated with similar prompt sentences and emotion states, allowing reuse of partial results and reducing the number of full generative calls. These techniques lower latency and computational load relative to a naive system that regenerates full scenes on each small change.

The server improves precision and reduces errors by enforcing schema validation of configuration information. The server maintains a schema defining required fields, type constraints, and allowed ranges for parameters. After receiving generated text from the generative AI model, the server parses and validates the configuration against the schema. If the configuration violates constraints, the server generates an internal correction prompt sentence that instructs the generative AI model to correct specific structural issues, such as missing fields or invalid numeric ranges. This non-conventional loop between model output and schema validation ensures that final configuration information is structurally correct before reaching the digital content generation apparatus, reducing runtime errors in the content engine and improving stability.

The server uses internal scoring functions to evaluate layouts generated by the generative AI model. For example, the server computes a coverage score measuring how evenly objects are distributed, a path clearance score measuring whether a player can move without collisions, and a visibility score measuring whether key objects are visible from the default camera.

These scores are computed using geometric algorithms over configuration graphs. The server uses these scores to guide correction prompt sentences. If the path clearance score is below a threshold, the server adds instructions to the correction prompt sentence to widen aisles or move blocking objects. As a result, the system produces engine-ready configurations with improved usability and performance characteristics.

The generative AI model processes prompt sentences in a way that differs from traditional human design workflows. While a human designer may reason with high-level concepts and manually adjust objects one by one, the generative AI model internally uses an attention mechanism to consider entire sequences of tokens and relationships between components. This allows the model to generate globally consistent configurations, such as maintaining stylistic coherence across all objects in a scene or balancing difficulty across game levels. The server leverages this property by shaping the prompt sentences and by constraining outputs through schemas and evaluation, thereby utilizing the model's non-human design bias to optimize technical outputs.

The server thereby improves computer technology by coordinating a complex pipeline of data transformations in a specific manner: controlling token-level generation, schema-constrained parsing, engine-specific mapping, and emotion-aware adjustment. These processes are executed automatically by the server using defined algorithms and data structures, not merely reflecting a business process or abstract idea. The result is a technically improved method of generating and updating digital environments and electronic content that makes better use of computational resources, reduces communication overhead, increases processing speed, and yields higher-quality, engine-compatible configurations.

In another embodiment, the server uses a different generative AI model architecture such as a sequence-to-sequence recurrent network or a hybrid model combining rules and neural generation. The server may use distinct generative AI models for different sub-tasks, such as one model for environment layout, another model for narrative generation, and another model for parameter tuning. The server coordinates these models by exchanging intermediate representations, such as a high-level scene graph augmented by narrative tags. The terminal and digital content generation apparatus remain similar, but the internal data flows differ.

In another embodiment, the digital content generation apparatus is a two-dimensional animation tool or a video scene editor rather than a three-dimensional engine. In this case, the configuration information describes layers, sprites, timelines, and transitions instead of meshes and three-dimensional positions. The server uses the same prompt and configuration transformation framework, but the mapping function translates configuration entities into timeline events and layer setups. Emotion-based adjustments may change the pacing, color grading, or transition types used in the animation.

In another embodiment, the server uses a distributed architecture where multiple computing nodes handle different modules. A front-end node handles user-facing request acquisition and preview delivery, a mid-tier node handles generative AI model inference using dedicated accelerator hardware, and a back-end node handles content engine control and storage. The system can scale horizontally by adding more nodes for generative AI inference or content generation. The internal data structures and flows remain the same, but the physical deployment improves throughput and reliability.

Through these various embodiments and alternatives, the server, terminal, and digital content generation apparatus cooperate to implement the claimed system. The system acquires natural language request information and emotion data from the user via the terminal, generates and refines prompt sentences, executes a generative AI model with a defined architecture and training regime, converts generative outputs into validated configuration information and engine-specific setting information, and orchestrates the digital content generation apparatus to generate and adjust virtual environments and electronic content. Because of the specific data structures, algorithms, and control flows employed, the system improves the operation of computer-based content generation pipelines and produces technical effects such as increased speed, improved accuracy, reduced errors, and more efficient use of computational and communication resources.

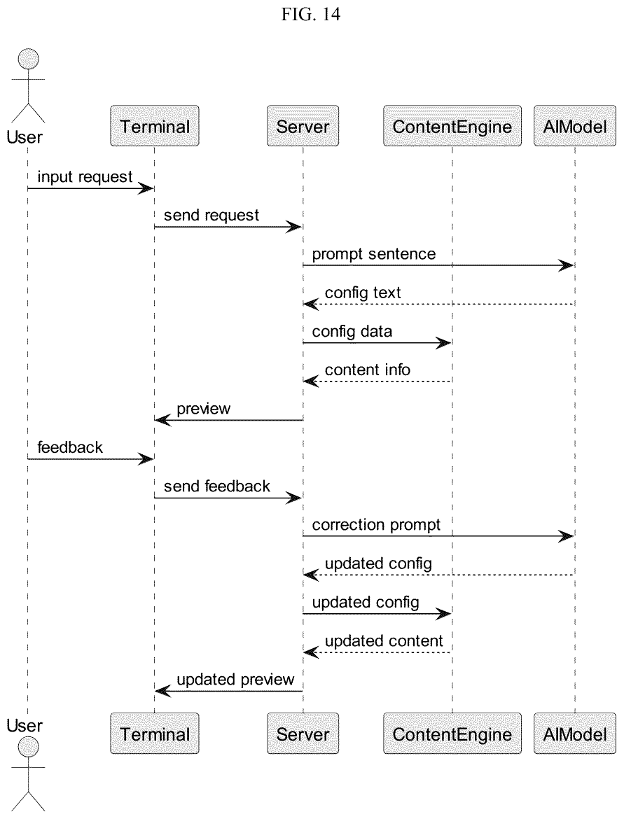

The following describes the processing flow using FIG. 14.

### Step 1:

User provides an initial request in natural language.

User inputs a description such as “I want to create a modern café-style virtual store” or “I want to create an action game where the player defeats a dragon in a fantasy world” into an input field on the terminal.

Input: free-form natural language text entered by the user.

Output: a UTF-8 encoded text string with associated metadata (user ID, project ID, timestamp).

Terminal converts keystrokes or speech-to-text results into a continuous text string, attaches identifiers, and sends the resulting data packet to the server via a network connection.

### Step 2:

Server normalizes and stores the request information.

Server receives the text string and metadata from the terminal and performs preprocessing such as trimming whitespace, normalizing line breaks, and checking maximum length.

Input: user request text and metadata from the terminal.

Output: a normalized request record stored in a database and passed to later modules.

Server writes the normalized request into a persistent store with fields (request_id, user_id, project_id, raw_text, language, timestamp), thereby creating a structured record accessible by subsequent processing stages.

### Step 3:

Server generates a base prompt sentence from the user request.

Server uses the prompt generation module to embed the user's text into a predefined instruction template suitable for a generative AI model.

Input: normalized request record containing raw_text and context identifiers.

Output: a base prompt sentence string and a prompt record.

Server concatenates system instructions, the user request, and format requirements, for example producing:

“Design a 3D virtual store with the theme: modern café. Include a detailed object list, layout description, and visual style guidelines. User request: I want to create a modern café-style virtual store.”

Server stores the prompt sentence in a prompt log table linked to the request record.

### Step 4:

Server tokenizes the prompt sentence for the generative AI model.

Server applies a tokenizer to convert the prompt sentence into a sequence of token IDs recognized by the generative AI model.

Input: base prompt sentence string.

Output: a tokenized representation (sequence of integers) and an input tensor for the model.

Server splits the text into subword units, maps each unit to a token ID using a vocabulary, and pads or truncates the sequence to a model-acceptable length. Server forms an input tensor with dimensions (sequence_length, embedding_dimension) after embedding lookup.

### Step 5:

Server performs inference using the generative AI model.

Server feeds the input tensor into a transformer-based generative AI model executing on CPU and/or GPU hardware.

Input: model input tensor representing the tokenized prompt sentence.

Output: a sequence of output token IDs representing generated content.

Server causes the model to compute multiple self-attention layers, feed-forward layers, and normalization steps. At each decoding position, the model computes a probability distribution over the vocabulary, selects next tokens according to decoding rules (e.g., greedy or sampling), and accumulates them until an end condition is met.

### Step 6:

Server decodes the model output into generated text.

Server converts the output token sequence back into a human-readable text string that encodes configuration information.

Input: sequence of output token IDs produced by the generative AI model.

Output: generated response text, typically a structured description or pseudo-JSON configuration.

Server maps token IDs back to subwords, merges them into words, and reconstructs the full string. Server then removes extraneous markers and segments the text into logical parts such as object list, layout, and environment settings.

### Step 7:

Server parses the generated text into configuration information.

Server applies parsing rules and validators to transform the generated text into a structured configuration data object.

Input: generated response text containing descriptions of objects, positions, and environment parameters.

Output: configuration information including an object list, placement information, and environment parameters.

Server uses pattern matching, regular expressions, or grammar-based parsers to extract entities like “table,” “chair,” “light,” and to assign numeric values for positions, rotations, and densities. Server builds an internal configuration object graph with fields for each entity and relationship.

### Step 8:

Server validates and normalizes configuration information.

Server checks the configuration object graph against a schema defining required fields, data types, and valid ranges.

Input: raw configuration information from the parsing stage.

Output: validated and normalized configuration information, plus optional error or warning flags.

Server verifies that every object has a valid category, that positions are numeric, that counts and ranges are within allowable limits, and that references to assets are resolvable. Server adjusts units (for example, converting centimeters to meters), rounds values to engine-friendly precision, and flags missing or inconsistent data.

### Step 9:

Server converts configuration information into engine-specific setting information.

Server maps generic objects and parameters to identifiers and formats understood by the digital content generation apparatus.

Input: validated and normalized configuration information.

Output: engine-specific setting information such as engine asset IDs, scene graph entries, and environment configuration records.

Server replaces generic labels like “cafe_chair” with concrete engine asset names, converts spatial coordinates into the engine's coordinate system, and packs the result into structured data (for example, a scene configuration file or an in-memory data structure).

### Step 10:

Server sends setting information to the digital content generation apparatus.

Server communicates with the content engine via an application programming interface, providing the setting information as input for scene construction.

Input: engine-specific setting information.

Output: a transmission to the content engine and an acknowledgement or job identifier from the engine.

Server serializes the setting information, sends it over the network or inter-process channel, and triggers the content engine to instantiate objects, apply materials, and configure lighting according to the received data.

### Step 11:

Server acquires output information from the digital content generation apparatus.

Server receives the results of scene generation, including identifiers for generated files or renderings and runtime diagnostics.

Input: content engine job identifier and status notifications.

Output: output information including paths to generated scenes, preview images, and performance metrics.

Server collects the engine's response, stores metadata, and constructs a summary describing what has been generated and where it can be accessed.

### Step 12:

Server delivers preview and access information to the terminal.

Server sends to the terminal a response describing the current virtual environment or content state.

Input: output information from the content engine and configuration identifiers.

Output: preview data such as image URLs, play links, or descriptive summaries delivered to the terminal.

Server packages links and thumbnails into a response message and transmits it over the network to the terminal, which can then display them to the user.

### Step 13:

Terminal presents the generated content preview to the user.

Terminal displays images, descriptive text, and interactive controls (for example, a “Play” button or camera controls) in a graphical interface.

Input: preview data and access URLs from the server.

Output: a rendered user interface allowing the user to inspect the generated environment or content.

Terminal uses a rendering engine (browser or native UI toolkit) to draw the preview and, when appropriate, launches a viewer or runtime to let the user experience the interactive content.

### Step 14:

User reviews the generated content and provides feedback.

User inspects the layout, density, style, or behavior of the generated virtual environment or game and decides to request changes.

Input: visual or interactive experience provided by the terminal.

Output: additional input information describing modifications, such as “Add more trees around the village” or “Increase the dragon's movement speed.”

User enters feedback through text fields, voice input, or other controls on the terminal.

### Step 15:

Terminal transmits feedback to the server.

Terminal converts the user feedback into text data with metadata about the currently displayed configuration or scene version.

Input: user feedback text and local context (e.g., current scene ID).

Output: a feedback message containing additional input information sent to the server.

Terminal packages the feedback into a structured message, attaches identifiers such as configuration version ID, and sends it via the network to the server.

### Step 16:

Server associates feedback with existing configuration and output.

Server looks up the configuration version and output information referenced in the feedback message.

Input: feedback message containing user feedback and scene or configuration identifiers.

Output: a feedback record linking user feedback to specific configuration and output data.

Server stores this association in a database, enabling later tracing of which feedback led to which changes and ensuring that subsequent steps operate on the correct version.

### Step 17:

Server derives evaluation information from output and configuration.

Server analyzes the output information and configuration to compute objective metrics such as object density, path clearance, or visibility.

Input: configuration information, output information, and feedback record.

Output: evaluation information summarizing technical qualities or issues in the current content.

Server runs geometric or structural algorithms over the configuration graph; for example, it measures average distance between objects or counts objects within a region. Server encodes these metrics into an evaluation data structure.

### Step 18:

Server generates a correction prompt sentence based on feedback and evaluation.

Server constructs a new prompt that instructs the generative AI model to modify the configuration to address the user's feedback and any technical issues identified.

Input: user feedback, evaluation information, and previous prompt or configuration context.

Output: a correction prompt sentence text.

Server combines description of the current state, user comments, and numeric metrics into a detailed instruction, such as “Increase chair count around the counter to at least 20 while maintaining at least 1 meter clearance for walkways.”

### Step 19:

Server tokenizes and feeds the correction prompt sentence into the generative AI model.

Server processes the correction prompt sentence in the same way as the initial prompt, preparing it for inference.

Input: correction prompt sentence text.

Output: model input tensor for revised generation.

Server tokenizes the correction prompt, constructs an input tensor, and forwards it to the generative AI model for updated configuration generation.

### Step 20:

Server obtains updated configuration information from the generative AI model.

Server decodes the updated output and re-parses it into configuration form.

Input: output token sequence resulting from the correction prompt.

Output: updated configuration information reflecting requested changes.

Server repeats the decode, parse, and validate processes, producing a new configuration graph that integrates user-requested modifications and any adjustments implied by evaluation.

### Step 21:

Server captures user emotion data via the terminal.

Terminal acquires facial images and/or voice audio while the user interacts with the content, and server receives these data.

Input: image frames of the user's face and audio samples of the user's voice.

Output: raw or preprocessed emotion-related data forwarded to the emotion recognition module.

Terminal streams or batches these data to the server, optionally after computing facial landmarks or audio features locally.

### Step 22:

Server estimates user emotional state using emotion recognition processing.

Server applies trained neural networks to the emotion-related data to determine the user's current emotional state.

Input: facial and voice data from the terminal.

Output: an emotional state label or vector, such as “joy,” “sadness,” or a probability distribution over emotion categories.

Server feeds image data into a convolutional model and audio features into a temporal model, then fuses outputs to generate a final emotion estimate.

### Step 23:

Server adapts prompt sentences and configuration based on emotional state.

Server uses the emotion estimate to modify future prompts and configuration parameters.

Input: emotional state estimate and current prompt or configuration context.

Output: emotion-adapted prompt sentences and adjusted configuration information.

Server, for example, increases brightness and decorative elements when detecting joy, or introduces more comforting narrative elements when detecting sadness, by inserting emotion-related constraints or goals into upcoming prompt sentences.

### Step 24:

Server converts the updated, emotion-adapted configuration into new setting information.

Server repeats the mapping to engine-specific formats while including emotion-driven parameter changes.

Input: updated configuration information incorporating both feedback and emotion adaptation.

Output: revised setting information for the digital content generation apparatus.

Server adjusts parameters such as object coloration, music track selection, animation speeds, or effect intensities based on emotional state and then sends the revised setting information to the content engine.

### Step 25:

Server instructs the digital content generation apparatus to regenerate or adjust content.

Server triggers the engine to rebuild or patch the scene or game prototype using the latest setting information.

Input: revised setting information and instructions (e.g., full rebuild or incremental update).

Output: a new or updated version of the virtual environment or electronic content generated by the engine.

Server optionally requests partial updates when only a subset of objects or parameters has changed, reducing processing time.

### Step 26:

Server returns the regenerated or adjusted content information to the terminal.

Server collects new output information from the engine and forwards it to the terminal for display.

Input: updated scene identifiers, preview images, and metrics from the content engine.

Output: updated preview and access data delivered to the terminal.

Server sends links to the revised content, enabling the terminal to show the updated environment or game state.

### Step 27:

Terminal presents the updated content and the cycle repeats.

Terminal updates its display to reflect the latest content and may continue capturing user inputs and emotions.

Input: updated preview data and access URLs from the server.

Output: a refreshed user interface presenting the new content and controls for further interaction.

Terminal allows the user to review changes, provide additional feedback, and continue iterating, while the server continues to manage prompt generation, generative AI model invocations, configuration transformations, and emotion-based adaptations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

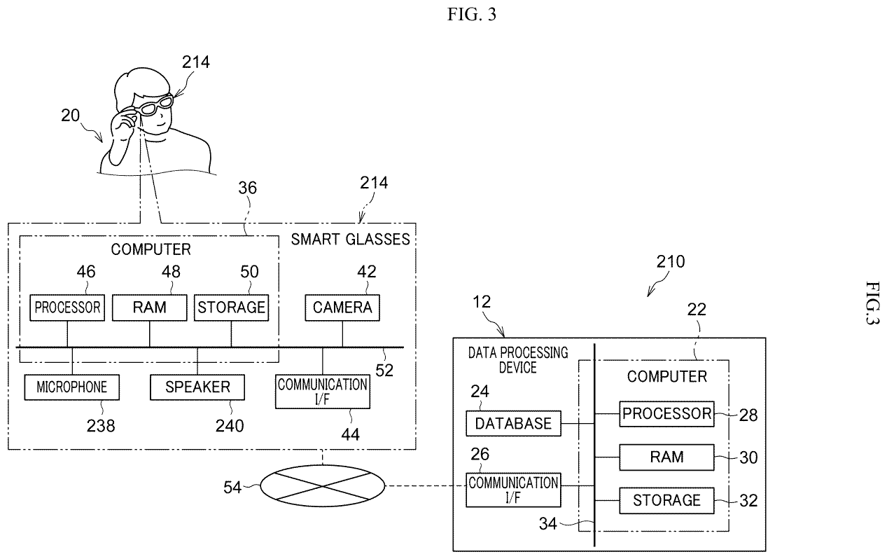

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

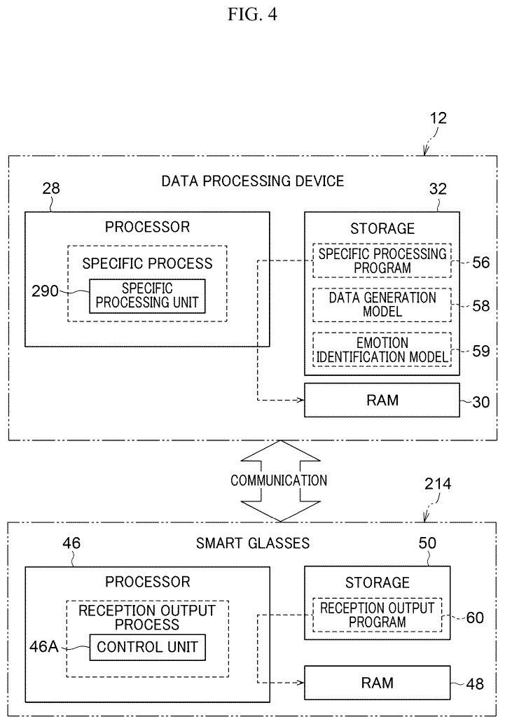

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

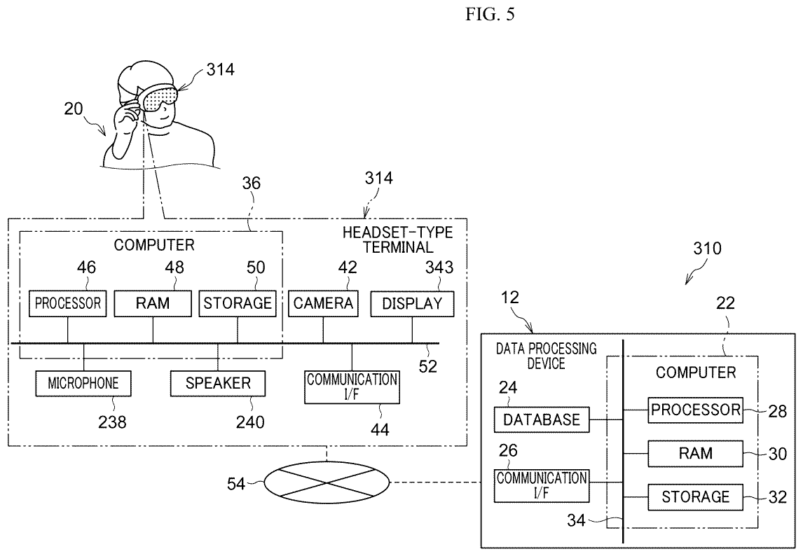

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

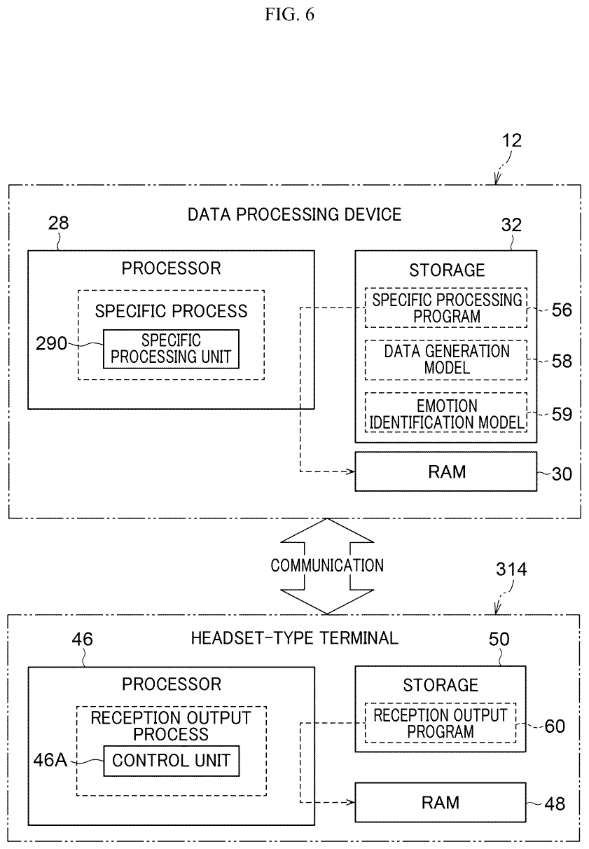

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

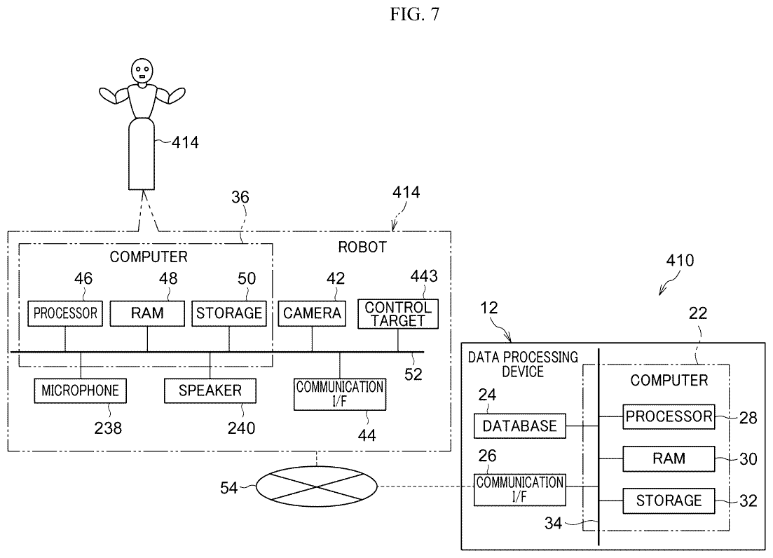

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

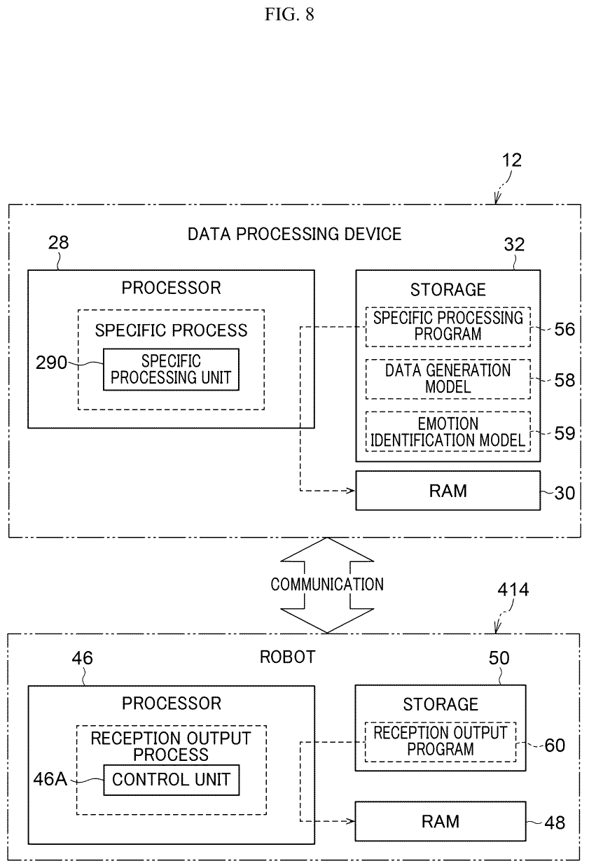

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

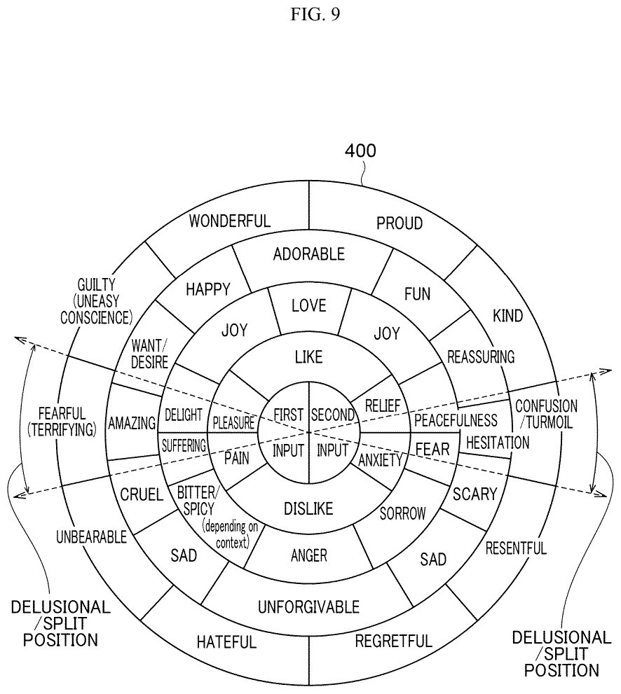

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

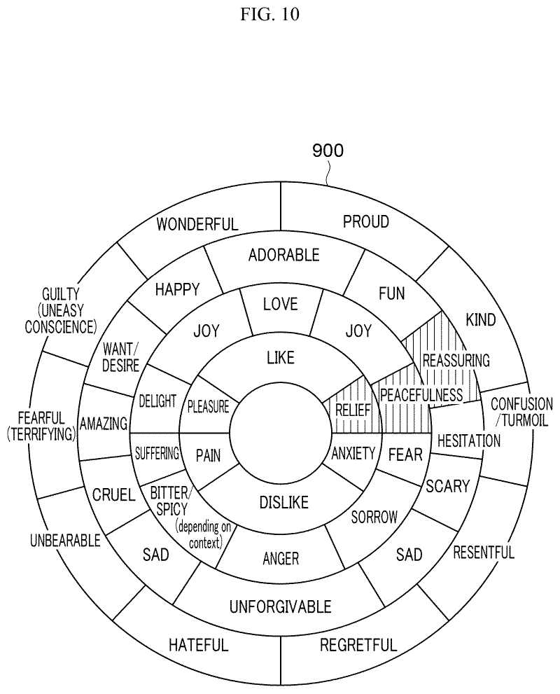

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive character information including a prompt sentence from a user terminal and store the character information in a storage device in association with user identification information and request identification information,
convert the prompt sentence stored in the storage device into model input data for an information processing apparatus including a generative AI model, input the model input data to the generative AI model to execute analysis processing based on natural language processing, and obtain analysis result data including structured information relating to a virtual environment,
extract entities, scenes, objects, events, and relationships included in the analysis result data, convert the extracted elements into intermediate data according to a data structure for content production of an interactive application, and convert the intermediate data into content generation data in a format usable by a digital content generation apparatus,
input the content generation data to the digital content generation apparatus having a three-dimensional content generation function or an interactive content generation function, and cause the digital content generation apparatus to generate digital content corresponding to the virtual environment,
analyze components included in the digital content based on an output from the digital content generation apparatus and generate evaluation description information indicating a correspondence relationship between the components and user intention based on the prompt sentence,
input the evaluation description information and the prompt sentence as comparison evaluation model input data to the generative AI model, and cause the generative AI model to generate evaluation result information including mismatch elements between the user intention and the digital content and modification proposals,
automatically correct at least a part of the intermediate data or the content generation data based on the evaluation result information, re-input corrected data to the digital content generation apparatus, and repeatedly execute regeneration processing of the digital content until a predetermined condition is satisfied, and
generate summary information relating to the digital content at a time of termination of the repeated execution and transmit the summary information to the user terminal.

### (Supplementary 2)

The system according to Supplementary 1,
wherein the processor is configured to
cause a display control function operating on the user terminal to present an input screen,
acquire a character string input by a user on the input screen as the character information, and cause a data communication function to transmit the character information via a communication network.

### (Supplementary 3)

The system according to Supplementary 1,
wherein the processor is configured to
automatically execute the digital content generation apparatus by using a batch processing function or a command-line processing function, supply the content generation data to the digital content generation apparatus as a data file on an external storage device, and acquire log information or status information indicating an execution result of a generation process performed by the digital content generation apparatus.

### Application Example 1

### (Supplementary 1)

A system comprising a processor,
wherein the processor is configured to
input a prompt sentence, which is obtained from a user operation terminal, into a generative AI model, and cause the generative AI model to analyze, based on instruction information including the prompt sentence, a world setting, actors, action objectives, and progression structure of a virtual environment; and
convert the world setting, the actors, the action objectives, and the progression structure of the virtual environment, which are obtained from the generative AI model, into intermediate structured information for generating code information and configuration information, automatically generate, based on the intermediate structured information, setting information and control information for a digital content generation apparatus, transmit the setting information and the control information to the digital content generation apparatus, and cause the digital content generation apparatus to construct a prototype of an interactive virtual environment; and
acquire, via the user operation terminal, evaluation information and correction requests from a user for the prototype constructed by the digital content generation apparatus, input, into the generative AI model, an additional prompt sentence including the evaluation information and the correction requests, partially update the intermediate structured information based on an output of the generative AI model, regenerate, based on the updated intermediate structured information, the setting information and the control information for the digital content generation apparatus, and cause the prototype to be iteratively updated; and
generate distribution information for causing a content distribution platform to publish a final version of the interactive virtual environment generated by the digital content generation apparatus and explanatory information of the interactive virtual environment, in response to an approval of the prototype from the user, and transmit the distribution information to the content distribution platform.

### (Supplementary 2)

The system according to supplementary 1,
wherein the processor is configured to use, as the digital content generation apparatus, a content generation engine capable of automatically configuring three-dimensional interactive content, and to automatically arrange and connect a virtual space, actor objects, and interaction control processing based on the intermediate structured information.

### (Supplementary 3)

The system according to supplementary 1,
wherein the processor is configured to use, as the generative AI model, a generative learning model having a natural language processing function, and to extract, from the prompt sentence and the additional prompt sentence, the world setting, actor attributes, action objectives, progression structure, and dialogue information of the virtual environment, and output the extracted information as the intermediate structured information in a machine-readable format.

### Example 2

### (Supplementary 1)

A system comprising a processor,
wherein the processor is configured to
receive input information including a prompt sentence from a user terminal and convert the input information into model input data to be input to a generative AI model, and cause the generative AI model to analyze settings and contents of a virtual environment based on the prompt sentence,
acquire structured data output from the generative AI model, the structured data including types, quantities, attributes, and relationships of objects to be placed in the virtual environment, and, on the basis of the structured data, refer to resource information stored in a resource information storage unit and convert the structured data into placement information including identification information of object resources and placement positions of the object resources,
convert the placement information into placement instruction data interpretable by a digital content generation apparatus and transmit the placement instruction data to the digital content generation apparatus so as to cause the digital content generation apparatus to construct the virtual environment,
acquire placement result information indicating an actual placement result of the objects in the virtual environment from the digital content generation apparatus and acquire feedback information relating to the virtual environment from the user terminal, generate analysis input data including the prompt sentence and the placement result information, and input the analysis input data to the generative AI model so as to cause the generative AI model to generate correction instruction data for correcting the virtual environment, and update the placement instruction data on the basis of the correction instruction data and re-transmit updated placement instruction data to the digital content generation apparatus so as to iteratively correct placement of the objects in the virtual environment.

### (Supplementary 2)

The system according to supplementary 1,
wherein the processor is configured to cause the digital content generation apparatus to comprise a content generation engine capable of generating content using three-dimensional representation or a content creation software capable of editing content in response to user operation, and to cause the digital content generation apparatus to construct the virtual environment as scene information for display on a screen based on the identification information of the object resources and the placement positions included in the placement instruction data.

### (Supplementary 3)

The system according to supplementary 1,
wherein the processor is configured to cause the generative AI model to comprise a machine learning model capable of performing natural language processing, and to cause the generative AI model to perform semantic analysis and relationship analysis on input including the prompt sentence and the placement result information, and to output, as the structured data or as the correction instruction data, information representing types of the objects, spatial relationships between the objects, and configuration conditions of the virtual environment.

### Application Example 2

### (Supplementary 1)

A system comprising a processor,
wherein the processor is configured to
acquire, by using an information processing apparatus, request information in natural language provided from a user, and generate a prompt sentence to be analyzed from the request information, and
input the prompt sentence into a generative AI model and cause the generative AI model to generate configuration information of a virtual environment or electronic content based on the request information, and
convert the configuration information obtained from the generative AI model into setting information that is referable by a digital content generation apparatus executing virtual space generation processing, and transmit the setting information to the digital content generation apparatus, and
acquire output information of the virtual environment or the electronic content generated by the digital content generation apparatus, and present the output information to the user, and acquire, from the user, additional input information including a modification request for the output information, generate a correction prompt sentence to be input into the generative AI model in accordance with the additional input information and evaluation information based on the output information, and re-input the correction prompt sentence into the generative AI model to update the configuration information, and
execute emotion recognition processing to estimate an emotional state of the user based on facial information or voice information of the user, and dynamically adjust at least one of the prompt sentence, the correction prompt sentence, and the setting information in accordance with the emotional state, and
instruct the digital content generation apparatus to regenerate or adjust the virtual environment or the electronic content in accordance with the updated configuration information and the emotional state.

### (Supplementary 2)

The system according to supplementary 1,
wherein the processor is configured to
use, as the digital content generation apparatus, a general-purpose content generation engine for constructing a three-dimensional digital space or an interactive content creation development platform, and automatically set object placement and visual effects in the virtual environment based on an object list and placement information included in the configuration information.

### (Supplementary 3)

The system according to supplementary 1,
wherein the processor is configured to
use, as the generative AI model, a machine learning model having a natural language processing function, and integratively analyze information included in the prompt sentence, the additional input information, and information regarding the emotional state, and output the configuration information, modification information, and adjustment information for emotion adaptation of the virtual environment or the electronic content.

What is claimed is:

1. A system comprising:
circuitry configured to:
receive, via a communication interface coupled to a packet-switched network, input data comprising a natural-language description from a terminal device;
convert the input data into model input data and transmit the model input data to a generative model to cause the generative model to output structured data representing elements to be arranged in a digital environment;
convert the structured data into intermediate data according to a content-production data structure and transform the intermediate data into instruction data interpretable by a content generation apparatus;
transmit the instruction data to the content generation apparatus via the communication interface to cause the content generation apparatus to construct the digital environment;
receive, from the terminal device, feedback data relating to the constructed digital environment; and
generate, based on the feedback data and the structured data, correction instruction data for modifying the digital environment and retransmit updated instruction data to the content generation apparatus.

2. The system according to claim 1, wherein the circuitry is configured to:
iteratively repeat generation of the correction instruction data and retransmission of the updated instruction data until a predetermined convergence criterion is satisfied.

3. The system according to claim 2, wherein the predetermined convergence criterion comprises at least one of an evaluation score threshold, a maximum iteration count, or a completion flag derived from comparison of the structured data against an output state of the content generation apparatus.

4. The system according to claim 1, wherein the circuitry is configured to:
extract, from the structured data, entity information, scene information, object information, event information, and relationship information, and
map the extracted information to fields of the content-production data structure to generate the intermediate data.

5. The system according to claim 4, wherein the circuitry is configured to:
reference resource information stored in a resource storage unit to associate each element in the intermediate data with identification information of a corresponding digital resource and a placement position in the digital environment.

6. The system according to claim 1, wherein the content generation apparatus comprises at least one of a three-dimensional content generation engine or an interactive content creation tool, and the instruction data comprises configuration parameters for at least one of geometry placement, lighting, or animation within the digital environment.

7. The system according to claim 6, wherein the circuitry is configured to:
execute the content generation apparatus via at least one of a batch processing function or a command-line processing function, and
acquire log information indicating an execution result of a generation process performed by the content generation apparatus.

8. The system according to claim 1, wherein the circuitry is configured to:
generate evaluation description information indicating a correspondence between components of the constructed digital environment and user intent derived from the input data, and
transmit the evaluation description information together with the input data to the generative model to obtain the correction instruction data.

9. The system according to claim 1, wherein the generative model comprises a transformer-based language model, and the circuitry is configured to:
tokenize the model input data into token sequences,
transmit the token sequences to the transformer-based language model, and
decode output token sequences to obtain the structured data.

10. The system according to claim 1, wherein the circuitry is configured to:
store the input data in a storage device in association with user identification information and request identification information, and
generate summary information describing main components of the constructed digital environment upon termination of iterative correction.

11. The system according to claim 10, wherein the circuitry is configured to:
transmit the summary information to the terminal device via the communication interface for presentation to a user.

12. The system according to claim 1, wherein the circuitry is configured to:
analyze the input data using natural language processing to extract semantic information comprising entities, spatial relationships, constraints, and behavioral conditions relevant to the digital environment.

13. The system according to claim 12, wherein the semantic information further comprises at least one of a world setting, actor attributes, action objectives, or a progression structure of the digital environment.

14. The system according to claim 1, wherein the circuitry is configured to:
generate distribution data for publishing a final version of the digital environment on a content distribution platform, and
transmit the distribution data to the content distribution platform in response to an approval signal received from the terminal device.

15. The system according to claim 1, wherein the circuitry is configured to:
estimate an emotional state of a user based on at least one of text data, audio data, or image data received from the terminal device, and
dynamically adjust at least one of the model input data or the instruction data based on the estimated emotional state.

16. The system according to claim 1, wherein the terminal device comprises at least one of a mobile computing device, a wearable display device, a headset-type terminal, or a robotic apparatus, each coupled to the packet-switched network via the communication interface.

17. The system according to claim 16, wherein the terminal device comprises the wearable display device including a microphone and a speaker, and the circuitry is configured to:
receive audio data representing user speech from the wearable display device, and
transmit audio output data to the speaker of the wearable display device.

18. The system according to claim 1, wherein:
the circuitry comprises a processor, a memory storing a program, a communication interface, and a storage device,
the processor executes the program to implement conversion of the input data into the model input data and generation of the instruction data,
the storage device stores the structured data, the intermediate data, and the instruction data, and
the communication interface exchanges data with the terminal device and the content generation apparatus over the packet-switched network.

19. The system according to claim 18, wherein the storage device comprises a resource information storage unit that associates object type identifiers with corresponding digital resource identifiers and placement parameters.

20. A method performed by circuitry, the method comprising:
receiving, via a communication interface coupled to a packet-switched network, input data comprising a natural-language description from a terminal device;
converting the input data into model input data and transmitting the model input data to a generative model to cause the generative model to output structured data representing elements to be arranged in a digital environment;
converting the structured data into intermediate data according to a content-production data structure and transforming the intermediate data into instruction data interpretable by a content generation apparatus;
transmitting the instruction data to the content generation apparatus via the communication interface to cause the content generation apparatus to construct the digital environment;
receiving, from the terminal device, feedback data relating to the constructed digital environment; and
generating, based on the feedback data and the structured data, correction instruction data for modifying the digital environment and retransmitting updated instruction data to the content generation apparatus.
